(19) United States
(12) Patent Application Publication
(10) Pub. No.: US 2015/0257109 A1
(43) Pub. Date: Sep. 10, 2015

(54) SYSTEM FOR PORTABLE OBJECT MANAGEMENT AND METHOD FOR USE THEREOF

(71) Applicant: Jon Lou Inc., Wilmington, DE (US)

(72) Inventors: Theodora KOULLIAS, Staten Island, NY (US); Marinel PETROV, Glendale, NY (US)

(21) Appl. No.: 14/639,771

(22) Filed: Mar. 5, 2015

Related U.S. Application Data
(60) Provisional application No. 61/948,951, filed on Mar. 6, 2014.

(51) Int. Cl. H04W 52/02; H04B 1/3888; H04W 8/20; H04M 1/18

(52) U.S. Cl. CPC H04W 52/0296; H04W 52/0251; H04M 1/185; H04B 1/3888; H04W 52/0258; H04W 8/205

(57) ABSTRACT

A system for portable object management and a method for use thereof is presented. The system includes a portable power container having a power supply and compartments shaped to store mobile devices. The mobile devices are electrically coupled to an electrical distribution system that supplies power from the power supply to the mobile devices. A electronically readable tangible storage medium holds instructs that cause a controller to monitor power consumption by the mobile device over time and regulate the power supplied from the power supply to the mobile devices. Methods of using this system are also disclosed.

### CROSS-REFERENCES TO RELATED APPLICATIONS

This application claims the benefit under 35 U.S.C. §119(e) to U.S. Provisional Patent Application No. 61/948,951, entitled Portable Self-Lighting Power Container, filed Mar. 6, 2014, which is hereby incorporated by reference in its entirety.

### BACKGROUND

1. Field of Invention

The invention generally relates to a portable carrying container, and, more specifically, to a portable carrying container that assists a user of the container in managing his or her portable objects.

2. Description of Related Art

The advent of smartphones has changed the way in which people interact with their phones. Rapid advances in mobile Internet technologies now allow consumers to interact with, create, and share content based on physical location. They have empowered users with Internet access, music, audio/video playback and recording, navigation, communication, and even payment capabilities. With worldwide sales approaching more than six billion units in the year 2020, smartphones have essentially become the pocket computers of our time. They are running faster and more powerful features but, in order to remain portable, can provide only limited battery life. Processing power, feature-sets, and sensors are increasingly bottlenecked by battery life limitations, with the typical battery capacity of smartphones today being barely above 2,400 mAh. Particularly, li-ion batteries in 2015 are expected to have no more than a five percent greater unit charge (mAh) compared to a 2014 model of the same dimensions and voltage, with an estimated maximum increase of 30 percent before the technology hits a ceiling. This is an important limitation because li-ion batteries are the most widely-used battery in consumer electronics such as smartphones, which are increasingly regarded as a gateway to one's daily life, providing networking access to email, social networking, and messaging. As such, the management of battery life becomes an important task. The trend in creating battery solutions points not only to the need of a unified device that is always on, but to a population of people always carrying these devices on-the-go. This is important given that several aspects of mobile Internet usage distinguish it from other types of Internet access via devices like personal computers or laptops.

The limited battery life of devices is one problem, as is being able to find them in big and often deep bags, briefcases, and backpacks. Yet this problem also comes about with respect to other items, such as keys, wallets, and makeup; and can at times be dangerous. Struggling in a dark parking lot to find keys to a car, for example, can provoke unwanted attention and danger, regardless of gender. Mostly, however, it is the inconvenience of having to empty the portable carrying container of these items in order to find one specific thing.

The need to find items quickly within a portable carrying container is both important for safety and time effectiveness, and as such, often leads users to prematurely remove and hold items, such as keys or wallets. This behavior is often dangerous, as it can signal to others that the user is preparing to enter a home or car, for example, or intending to purchase an item. Today's mobile payments systems somewhat solve the problem of visible intent by disguising wallets within mobile devices; however, even this is not ideal, as today's smart mobile devices are lucrative targets for theft considering their high (re)selling price (absent a mobile contract). Additionally, today's solutions for locking and paying are often bulky, both in time and practice, requiring multiple keys to enter a home, for example, or requiring multiple steps to complete a payment: locate wallet, access wallet, remove cash or card, pay or swipe, confirm and sign (if using card), return excess cash or card to wallet, close wallet, return wallet to original location. Today's solutions for locking and paying are also unsafe, as non-authorized users can easily access and use keys and payment cards with ease. Mobile payment systems attempt to remove barriers to payment and to improve safety by facilitating a payment solely via a user's distinguishable biometric information (such as a fingerprint or cardiogram); but this method still requires a user to access the mobile device, a problem described in Section[0002].

Ensuring all necessary devices, personal items, and accessories are within a portable carrying container is important to users, especially for those who travel or change carrying containers frequently. Vexing is the issue of forgetting critical items, such as wallets, passports, keys, or mobile devices, behind in a home, office, car, or gym; particularly vexing is the issue of forgetting said items in temporal locations such as in airplanes, cabs, public transportation, or other public locations. Today's solutions offer bulky tags that connect to a device for tracking once physically attached to an item; but these solutions not only limit the association to that between device and item only, but also do not function across long-range distances.

As it is inherent to a portable carrying container to hold items and transport them, it is necessary to be able to quickly and easily locate said container if it goes missing. Such a capacity has only been allotted to mobile devices today, but given the increasingly personal nature of handbags, briefcases, luggage, and backpacks, containers often now contain very critical, secure information that if lost, can result in personal damage. As users increasingly spend as much on their carrying containers as they do on their devices, the need to prevent the loss of said container is further magnified.

Furthermore, the need for people to carry their devices also brings about the need to protect those devices. Today's bags, briefcases, and backpacks only provide limited protection from impact in the form of small metallic feet, at best; and often, this is the exception. Most times, there is a lack of a buffer to reduce the force of impact when the carrying container is dropped to the ground. There is a need not only for the protection of devices and other items held within a carrying container, but also for the protection of the carrying container itself, which can wear out and become wet or dirty.

The ability and thereby need for people to carry their devices and other portable electronic devices such as laptops along with their personal items brings about the issue of added weight. Especially if the carrying container is in the form of a purse or backpack, such added weight could be detrimental to the user over a longer period of time. As such, the need to ensure that the user carries an appropriate weight on a daily basis or whenever the carrying container is used is important for protecting the user from porting too much weight and causing potential damage, particularly to the back.

The implicit value of the items and devices toted by a portable carrying container also brings about the need for said container to protect from unauthorized entry. Currently, handbags, backpacks, briefcases, and luggage offer no advanced protection to outside or unwarranted entry besides via naturally incorporated hardware (such as zippers, turn-clasps, snap or magnetic buttons, etc.) and other design elements (such as Velcro closures, ties, drawstrings, etc.), or via externally incorporated elements such as padlocks or combination locks. When considering portable carrying containers that are used for travel, these solutions are outdated. In addition, the absence of security at baggage carousels/claims at airports also exaggerates the antiquity of the aforementioned solutions. In cases where even a locked carrying container can be taken from the carousel without an identity confirmation, then even padlocks and combination locks essentially add no protection. In a situation where an attempt is made to access but not take an unattended carrying container without authorization, such as could occur to a beach bag when its owner is swimming or to a backpack at a café/restaurant when its owner uses the restroom, the problem of security becomes even more vexing.

Securing items from unwarranted entry also brings up the issue of ownership. Currently, there is no method for identifying an owner of items such as keys and portable carrying containers aside from peripheral distinguishing elements such as tags (on luggage, for example), rewards cards (on keys, for example), or IDs, credit cards, and photos (in wallets, for example). This is often frustrating when attempting to return a lost item to an owner, as the most direct information is often left out due to privacy concerns.

Further, because personal items are usually carried together, they tend to be lost or stolen together (such as a mobile device, wallet, and keys which reside within a purse). As such, both digital personal information stored on devices (banking and payments accounts, business and personal emails, contacts, addresses, social accounts, passwords, photos, etc.) and physical personal information carried by the container are subject to theft and misuse. In the case of digital information, sometimes users may forget to manually back up their information from their portable electronic devices to their laptop, desktop, hard drive, or the cloud. Auto-backup systems have the authority to access an electronic device and periodically post to the cloud, access users may feel uncomfortable granting to a third party. This is important, as users feel increasingly protective of their personal information and prefer that it is located in one area and not easily accessible by third parties nor by unauthorized users.

### BRIEF SUMMARY OF THE INVENTION

Under one aspect of the invention, a system for portable object management and a method for use thereof is presented. In one embodiment, the invention includes a portable power container which includes a power supply, a compartment shaped to store the power supply, a compartment shaped to store a mobile device, an electrical distribution system for supplying power from the power supply to the mobile device, an electrical coupling connected to the electrical distribution system for electrically coupling the mobile device to the electrical distribution system, a controller electrically connected to the power supply, and an electronically readable tangible storage medium. The electronically readable tangible storage medium includes instructions that when executed cause the controller to monitor power consumption by the mobile device over time and regulate the power supplied from the power supply to the mobile device when the mobile device is electrically coupled to the electrical coupling.

In another embodiment of the invention, the portable power container also contains a light source that is electrically connected to the power supply disposed to illuminate the interior of the portable power container. In some embodiments the light source includes LED lighting.

In another aspect of the invention, the portable power container also has a closable opening, and the storage medium contains instructions that when executed cause the controller to supply power to the light source when the closeable opening is opened.

In another embodiment, the portable power container also contains an ambient light sensor and the storage medium has instructions that when executed cause the controller to regulate the power supplied to the light source based on information provided by the ambient light sensor.

The portable power container may also have at least two electrical couplings connected to the electrical distribution system for electrically coupling more than one mobile device to the electrical distribution system.

In some embodiments, at least a portion of the electrical distribution system is integrated within the lining of the portable power container.

In another aspect of the invention, the portable power container may use a fuel cell as a power source.

In some embodiments the electrical coupling of the portable power container may include at least one inductive charge coupling.

The portable power container may also have a protective base that absorbs shock.

In some embodiments, the portable power uses a sensor to determine when the mobile device is inside the portable power container.

Another aspect of the invention includes a method that includes obtaining a measurement of a current amount of power remaining in a power supply of a portable power container, transmitting a signal to cause a representation of the measurement to be displayed by a mobile device, estimating a rate at which power from the power supply is consumed by the mobile device when charging the mobile device with the power supply, determining a recommended power usage practice based on the rate at which power from the power supply is consumed, and transmitting a signal to cause a representation of the recommended power usage practice to be displayed by the mobile device.

In a further embodiment, the method may further include the step of estimating a period of time the power supply will retain power based on the rate at which power from the power supply is consumed.

In another embodiment, the method can also include the steps of receiving information about scheduled activities of a user of the mobile device, estimating an amount of power to be consumed by the scheduled activities, and determining the recommended power usage practice being further based on the estimated amount of power to be consumed by the scheduled activities.

In still another embodiment, the method may include the steps of determining that too little power consumption data is available from the user to personalize a recommended power usage practice and using outside data sources to recommend a power usage practice.

In yet a further embodiment the method may also include the step of the power supply charging the mobile device in accordance with the recommended power usage practice when the mobile device is electrically coupled to the power supply.

In another embodiment, the method could also include the steps of, the mobile device estimating its own power consumption, wireless transmission of the power consumption estimation by the mobile device, and use of the power consumption information when making recommended power usage practice.

Any of the aspects or features of the embodiments set forth herein can be combined with any other aspects or embodiments.

### BRIEF DESCRIPTION OF FIGURES

FIG. 1a is a perspective view of a portable power container, in accordance with some embodiments.

FIG. 1b is a side view of an open version of a portable power container, in accordance with some embodiments.

FIG. 1c is a side view of a closed version of a portable power container, in accordance with some embodiments.

FIG. 1d is a front view of a compartment for storing a power supply, in accordance with some embodiments.

FIG. 1e is a side view of a compartment for storing a power supply, in accordance with some embodiments.

FIG. 2a is a perspective view of a lighting frame of a portable power container, in accordance with some embodiments.

FIG. 2b is a system diagram illustrating the components used for controlling a lighting frame, in accordance with some embodiments.

FIG. 3a is a hardware/software diagram showing the interaction between a power supply and portable electronic devices, in accordance with some embodiments.

FIG. 3b is a flow chart illustrating a method for measuring and reporting power status, in accordance with some embodiments.

FIG. 3c is a flow chart diagramming the interaction between a power supply and portable electronic devices, in accordance with some embodiments.

FIG. 3d is a flow chart illustrating a method of obtaining a measurement of the current power remaining in a power supply, in accordance with some embodiments.

FIG. 3e is a flow chart illustrating a method of tracking and displaying the power level of a power supply over a period of time, in accordance with some embodiments.

FIG. 3f is a flow chart illustrating a method of determining how much power a user consumes, in accordance with some embodiments.

FIG. 3g is a flow chart illustrating a method of recommending the number of power supply cartridges needed to meet the power consumption needs of a user, in accordance with some embodiments.

FIG. 4a is a high-level diagram depicting the interaction between a user's container and a reading system for an identification/authentication system, according to some embodiments.

FIG. 4b is a flow chart illustrating the general process by which a container transmits information to a reading system, in accordance with some embodiments.

FIG. 4c is a flow chart illustrating how a transaction via a container and reading system is processed, in accordance with some embodiments.

FIG. 4d is a flow chart illustrating the container's internal transaction process, in accordance with some embodiments.

FIG. 4e is a flow chart illustrating how an ID chip embedded within the container verifies the user's biometric information, in accordance with some embodiments.

FIG. 5a is a high-level flow chart of how the container ensures it is connected to all the peripheral items that a user has chosen to connect to, in accordance with some embodiments.

FIG. 5b is a detailed flow chart illustrating how the container identifies the associated items, in accordance with some embodiments.

FIG. 5c is a diagram exemplifying various embodiments of portable carrying container and the interconnectivity between the containers facilitated by various embedded communicating technologies, in accordance with some embodiments.

FIG. 6 is a flow chart illustrating the method, in some embodiments, by which a container can be located should it be stolen or go missing.

FIG. 7 is a perspective view of a protective base installed on the exterior bottom of a portable power container, in accordance with some embodiments.

FIG. 8 is a flow chart illustrating how the embedded pressure sensor communicates to the user that the container is too heavy for carrying, according to some embodiments.

FIG. 9 is a flow chart illustrating the main steps leading to the backup of data from the mobile device to the container, according to some embodiments.

FIG. 10 is a diagram illustrating the multiple functions of a computerized method that acts to interface any and all technological integrations within the container to the user, according to some embodiments.

### DETAILED DESCRIPTION

As previously described, current consumers face several issues. First, battery life of portable devices often does not meet consumer demand, frequently leaving consumers with devices that are inoperable due to a drained battery (i.e., “dead” devices). Second, consumers have trouble finding items in their portable carrying containers. Third, they have trouble retrieving those items efficiently and safely, so as not to reveal intent and expose themselves to unnecessary risks, including the risk of having someone unauthorized used their personal items for malicious intent. Fourth, items that are normally carried inside these containers are often forgotten or separated from the carrying container. Fifth, consumers have no surefire way of actively locating a carrying container if said container is misplaced or lost. Sixth, portable carrying containers and items that are consequently carried inside these containers are not adequately protected from wear and force of impact. Seventh, the portability of many electronic devices and personal items exposes consumers to carrying too much weight which can be detrimental over the long run. Eighth, consumers face the risk of unwarranted access to their carrying containers, and as such, must always keep an eye on or continuously carry or be near said containers. Ninth, lost or stolen portable carrying containers and other personal items are difficult to return to the owner because there is no surefire way of identifying said owner. Finally, consumers face the risk of losing personal digital information that may be stored on a device carried by a container or other personal item that has been lost if the device itself has not been backed up, information that is nearly impossible to retrieve if the device itself goes missing.

One solution is a portable carrying container integrated with a power source for charging multiple portable devices at once. In some embodiments, a light source seamlessly integrated within the hardware of the portable container will provide illumination. In some embodiments, a biometric identifier and an ID chip seamlessly integrated within the carrying container provide a system of checks to confirm a user's identity. In some embodiments, a wireless personal area network (WPAN) technology seamlessly integrated within the carrying container and within the items the container provide a network for associating and disassociating items that a user may wish to continuously carry within the portable container. In some embodiments, location tracking or location-based systems such as a wireless wide area network (WWAN), wireless local area network (WLAN), ID chip, or global positioning system (GPS) and/or geographic information system (GIS) integrated within the carrying container will provide tracking capacity to the container. In some embodiments, a protective base will be installed on the external bottom of the portable container to protect both the handbag and the interior-housed technology. In some embodiments, a pressure sensor will be integrated between the materials making up the carrying container's carrying elements, such as the straps or handles, to determine the applied pressure of the container's weight onto the user. In some embodiments, a laser-etched tag with a serial number will be permanently attached to a hidden yet accessible portion of the container to provide finders of lost said container with the ability to report said container. In some embodiments, the carrying container will communicate with the finder's device, notifying the finder that said container has been lost or stolen. In some embodiments, a computer data storage unit will be embedded within the container to store and back up data transmitted by the devices being charged by the integrated power source. In some embodiments, a processing unit will be integrated near and to the power source to facilitate the communication between any or all integrated technologies.

In some embodiments, the power source will be integrated within the lining of the container during manufacturing so users will not see nor interact with the power source, cables, or wires within the cavity of the handbag. In some embodiments, the biometric identifier will be seamlessly integrated into the handles or straps used to carry the container, or at a location where the user normally and most easily comes into contact with the container. In some embodiments, the ID chip will be integrated near and connected to a power source, so as to communicate with an appropriate reader as well as store information about the user and container's ID. In some embodiments, the biometric identifier and ID chip will act together to provide an identity, proximity, and container authentication check for facilitation of payments; locking and unlocking a home, vehicle, or office; checking into airports or hotels; or having the container serviced at an appropriate location without the need for a user to take out a phone, wallet, keys, ID, passport, or for a service agent to look up information about the user's purchase or container service history. In some embodiments, the wireless personal area network (WPAN) integrated near and connected to a power source will communicate with the WPAN of the registered mobile devices to keep track of the items set by the mobile application to be associated with the container. In some embodiments, the tracking source will be integrated near and connected to a power source, so as to continuously communicate with the appropriate radios, readers, or satellites about the container's location. In some embodiments, the tracking source and WPAN or ID chip will work together to confirm the identity of the connected device and automatically send the location of the carrying container to the user's mobile application. In some embodiments, the pressure sensor and WPAN will act together to transmit the applied pressure by the carrying container onto the user to a mobile application. In some embodiments, the biometric identifier and WPAN or ID chip will act together to provide an identity, proximity, and container authentication check in order to lock the carrying container, so as to prevent unauthorized users from entering said container. In some embodiments, the embedded WPAN, WLAN, WWAN will act to transmit a message to any open port listening on peripheral devices up to a certain radius away to notify the owners of these devices that said container is lost or stolen. In some embodiments, the WPAN or ID chip will act to confirm the identity of the connected device and act to back up the data on the connected device each time the device is being charged by the integrated power source. In some embodiments, the WLAN or WWAN will act to upload the accumulated data from the computer data storage unit to another of the user's mobile applications or to the user's virtual private server (VPS) or to another VPS, or to transmit the accumulated data to a display via streaming.

In some embodiments, a mobile application for the power supply will inform the user when it is time to recharge or to purchase new power supply cartridges. In some embodiments, a device connected to the power supply will automatically sync to the mobile application that will provide details about power usage and charging needs. In some embodiments, a mobile application will allow the user to control the status, timing, intensity, and activators of the integrated light source. In some embodiments, a mobile application will allow a user to associate and disassociate items carried by the container. In some embodiments, a mobile application will allow a user to set a visual, aural, or tactile reminder via an integrated source or via mobile messaging that an item associated with the handbag is missing. In some embodiments, a mobile application will automatically inform the user via notification or other messaging form of the container's location if an unregistered device is connected to the power supply. In some embodiments, the mobile application will also inform the user of the container's location when prompted. In some embodiments, a mobile application will convert the pressure sensed by the pressure sensor embedded into the container's carrying elements into a weight measurement to inform the user of the weight being carried and whether this weight is appropriate for the user to be carrying. In some embodiments, a mobile or web application can override the triaged authentication check to virtually control the physical locking and unlocking of the container; in this case, both the mobile and web applications would, optionally, require biometric authentication to grant access to the container. In some embodiments, a web application will allow for the entry of a laser-etched serial number located on the container to anonymously transmit the location of the container from finder to owner using the IP address of the finder's accessed web application. In some embodiments, a mobile application will allow for entry of personal information to be shared via message to a finder of a lost or stolen carrying container. In some embodiments, the mobile app will allow a user to control the activity, frequency, and type of data backup that occurs, as well as the streaming of said data.

One particular embodiment of portable power container is a handbag integrated with a fuel cell power source, LED lighting, fingerprint sensor, active RFID chip (ID chip), Bluetooth LE (WPAN), cellular network chip with 4g (or 5G) accessibility (WWAN), WiFi chip (WLAN), pressure sensor, laser-etched serial number tag, secondary storage device/solid state hard drive, and microprocessor.

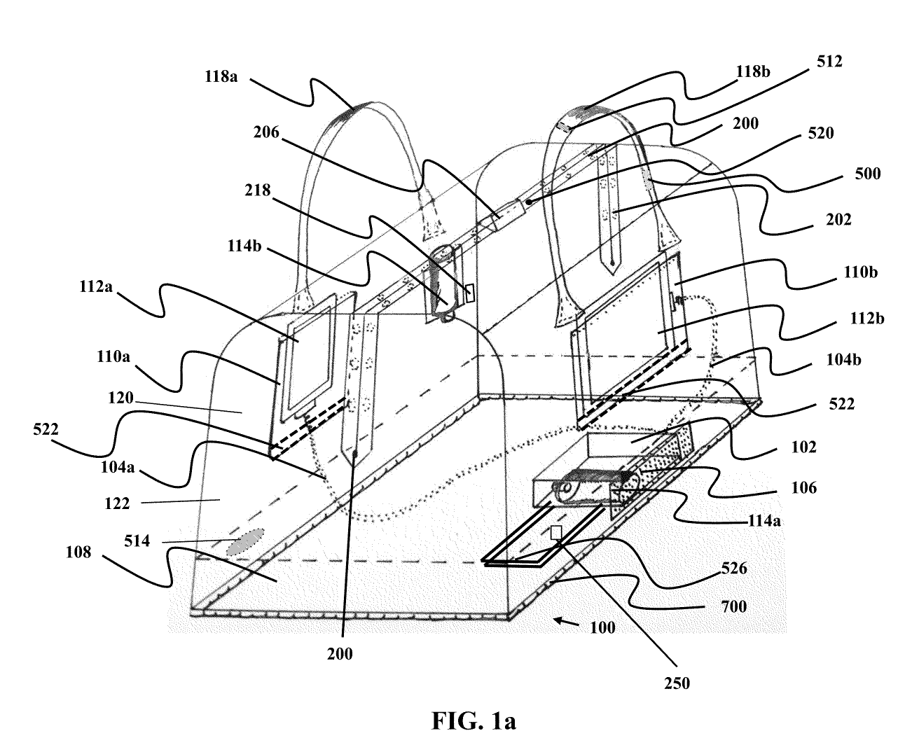

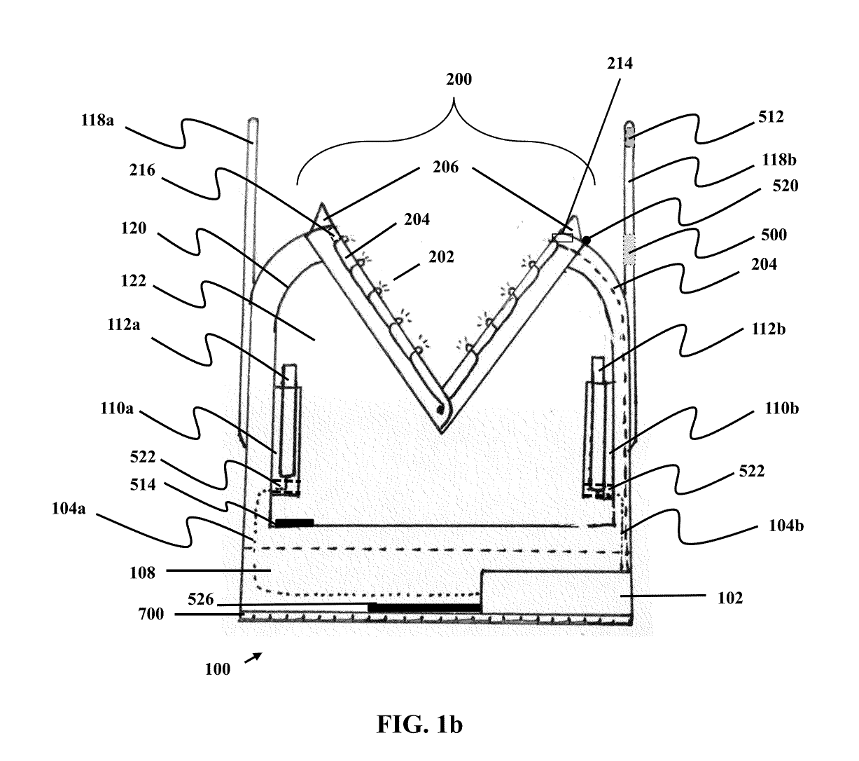

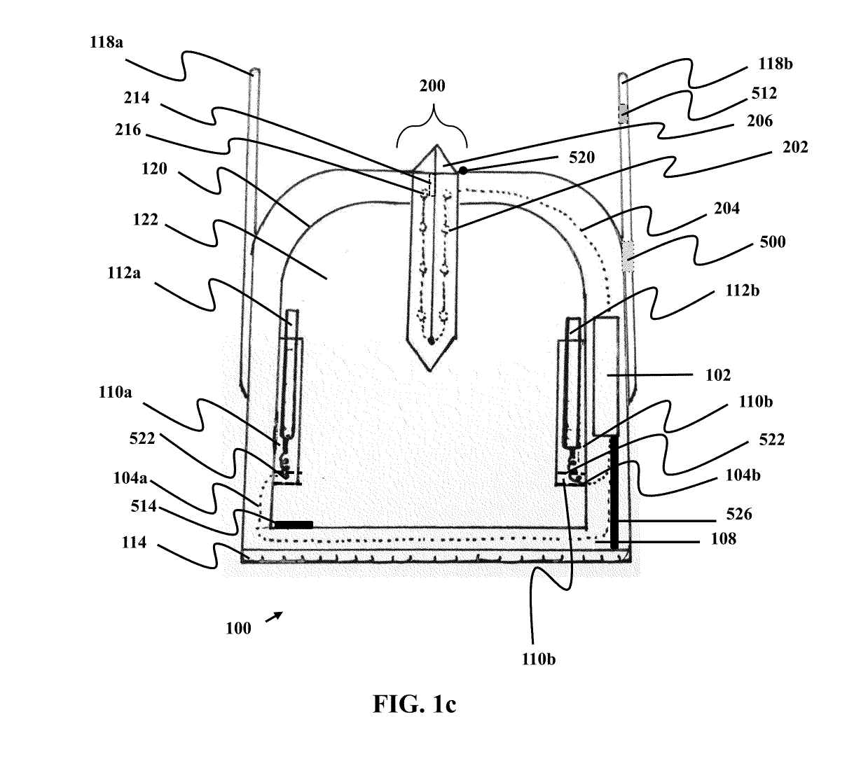

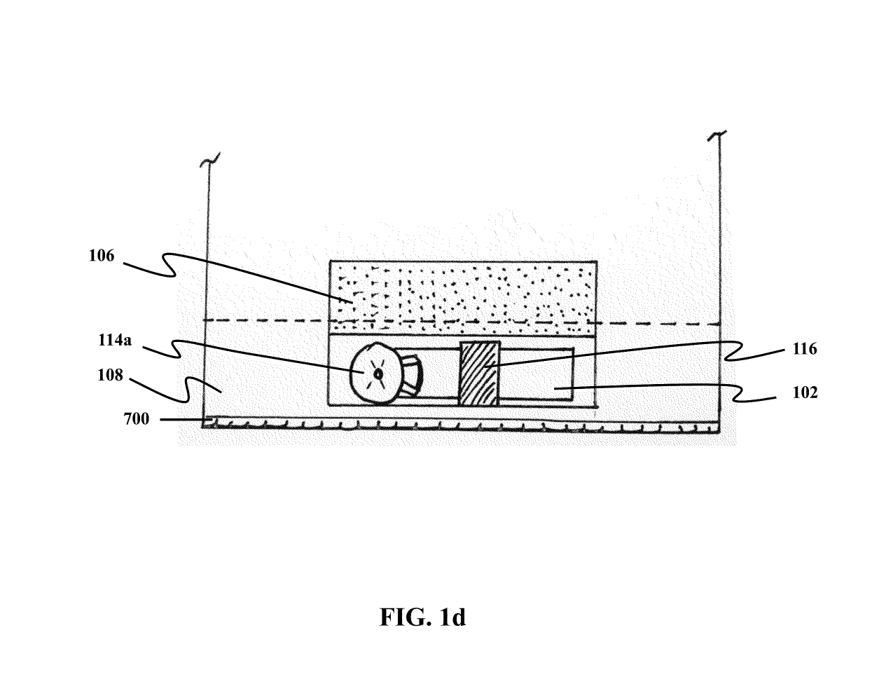

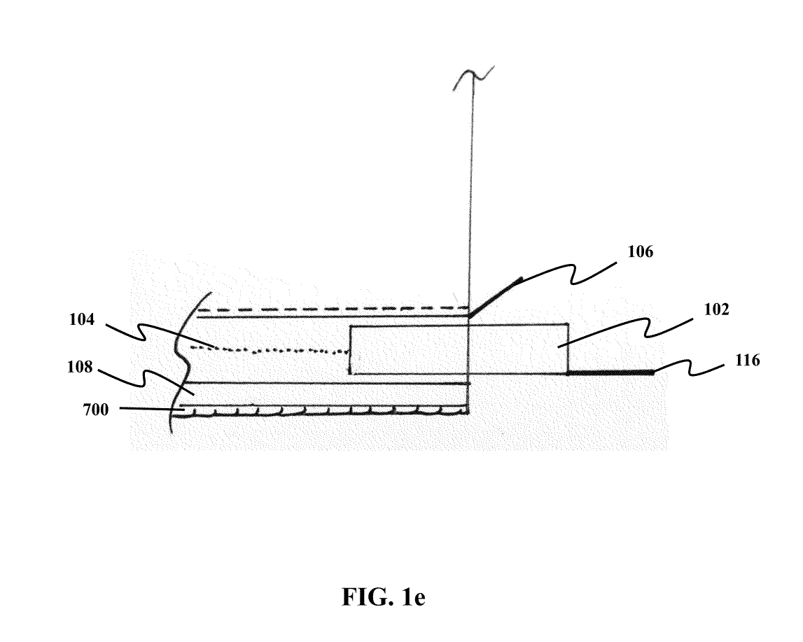

FIG. 1a is a perspective view of a portable power container 100, according to some embodiments. Portable power container 100 includes a power supply 102, two cords 104a and 104b, a perforated flap 106, three compartments 108, 110a and 110b, portable electronic devices 112a and 112b, power supply cartridge 114a, extra power supply cartridge 114b, two handles 118a and 118b, a lighting frame 200, light source 202, a mechanical or magnetic latch and/or lock mechanism electrically connected to the power supply 206, a light source switch 218, a protective base 700, a biometric identifier 500, pressure sensor 512, laser-etched tag 514, contactless connector for wireless power 522, item association indicator 520, circuit board 526, and control circuit 250. Circuit board 526 can comprise any or all of the following communicative, processing, control and storage technologies; and ID verification chip, a wireless personal area network (WPAN), a wireless wide area network (WWAN), a wireless land area network (WLAN), a GPS, a computer data storage unit or host device, and/or a transaction processing chip. Cords 104a and 104b are used for connecting the power supply to a mobile device. Compartment 108 stores the power supply 102 and cords 104a and 104b. Compartment 108 is integrated into the base of the portable power container 100 underneath a lining 120 so that users have only limited access to the power supply 102 and cords 104a and 104b, and so the main compartment 122 is less cluttered by the integrated components and less prone to damage by everyday use of portable power container 100. Compartments 110a and 110b are designed to fit portable electronic devices, have the corresponding charging cables, and are readily accessible by the user. A perforated flap 106 is used to open and close the power supply compartment. Because power supply 102 and cords 104a and 104b are built into compartment 108 of the portable power container during manufacturing, an accessible portion is useful for convenient access to power supply 102 for the replacement of power supply cartridge 114a by extra power supply cartridge 114b; and thus flap 106 is an opening where the user can access power supply 102. Inside the portable power container 100 is a dedicated compartment 110a for charging or holding a portable electronic device (PED) (smartphone, camera, headset, etc.) 112a and a dedicated compartment 110b for charging or holding another PED (tablet) 112b. The power supply 102 uses a power supply cartridge 114a and there is a compartment for storing an extra power supply cartridge 114b. The portable power container also has handles 118, interior lining 120, main compartment 122, and a protective base 700. Control circuit 250 may include an ID verification chip, a wireless personal area network (WPAN), a wireless wide area network (WWAN), a wireless land area network (WLAN), a GPS, a computer data storage unit or host device, and a transaction processing chip which are all integrated on circuit board 526 which is integrated near power source 102 as it needs to draw power for the integrated technologies in addition to be seamlessly embedded and be out of sight or access to a user via the container. Referring to FIG. 1a, item association indicator 520 can be visual, aural, or tactile, and as such is integrated into the container accordingly. FIG. 1a shows visual item association indicator 520 situated atop lighting frame 200, where it can be seen. Pressure sensor 512 is seamlessly integrated within the container's handles 118a and 118b by which a user will carry said container. Biometric identifier 500 is integrated atop the side of the handles 118a and 118b so that a user can more quickly and easily come into contact with the identifier. Laser etched tag 514, which assists in locating a lost container, is located within the container in a location where it remains unobtrusive yet still visible to and easily located by the owner and particularly finder, for which it is intended.

While the embodiment depicted in FIG. 1a is a structured handbag with a frame, those of ordinary skill in the art will understand that portable power container 100 could also be, for example, a handbag without a frame, a clutch, a backpack, luggage, a carry-on, a wallet, a laptop sleeve and/or other case for electronic devices, etc. Each of these alternative embodiments serves a different purpose (e.g., for school, for traveling, for a special occasion, for protection, etc.) and is used by different user groups (e.g., students, working professionals, etc.). However, a power source built into each of these embodiments would serve the much-needed purpose of keeping devices powered and people fully connected when they cannot charge their devices because they are not by a power outlet, or for a multitude of other reasons.

Power supply 102 is connected to cord 104. The power supply 102 can be any power supply, for example, one capable of connecting to a USB-enabled or wirelessly connected mobile device with cord 104 or contactless connector 522, used to charge the mobile device 112. For example, the power supply 102 can be a fuel cell, lithium ion microbattery, graphite solutions and graphene, liquid battery, magnesium based battery, supercapacitor, wind battery, kinetic based battery, thermacell, or piezoelectric powered battery.

Some embodiments include a fuel cell because it is lighter than some other sources of power, which aids integration into a portable power container. It is not necessary to recharge a fuel cell, and hence a fuel cell can provide rapid power via an easily accessible power refill cartridge. It is not necessary to plug the fuel-cell-integrated power container into an outlet to charge. This makes it unnecessary to find converters, power adapters and power outlets when users travel. A fuel cell is more efficient than some other forms of batteries. Fuel cells tend to charge, on average, 10-15 times faster than li-ion batteries, which is the most common power source used in consumer electronic devices. A portable power container with access to instant power means users can have a personal, easy, and safe way to recharge their devices. This is important, as most recently, users have had the security of their devices compromised (i.e., “hacked into”) while using public USB-enabled powering stations. A fuel-cell-integrated portable power container reduces this security issue.

In some embodiments power supply 102 is capable of charging mobile devices through inductive coupling, also known as wireless charging. Dedicated device pockets 110a and 110b help to maintain appropriate alignment between the devices 112a and 112b and inductive charging bases. Sufficient air flow is necessary to alleviate accumulation of heat due to inductive charging. In these embodiments cords 104a and 104b connect to charging bases which contain induction coils that create the electromagnetic field required to charge the mobile device when it is in contact with the base. In embodiments using inductive coupling the mobile device must be equipped to be charged using inductive coupling having for example an inductive coil or being in a case that has an inductive coil. In other embodiments the power supply 102 is employs resonant inductive coupling, also known as electrodynamic induction, allowing a greater distance between the charging base and the mobile device. In embodiments employing resonant inductive coupling the charging base could, for example, be in the compartment 108 and cords 104a and 104b could be removed. Using resonant inductive coupling mobile devices could be charged both in the bag or in the vicinity of the bag.

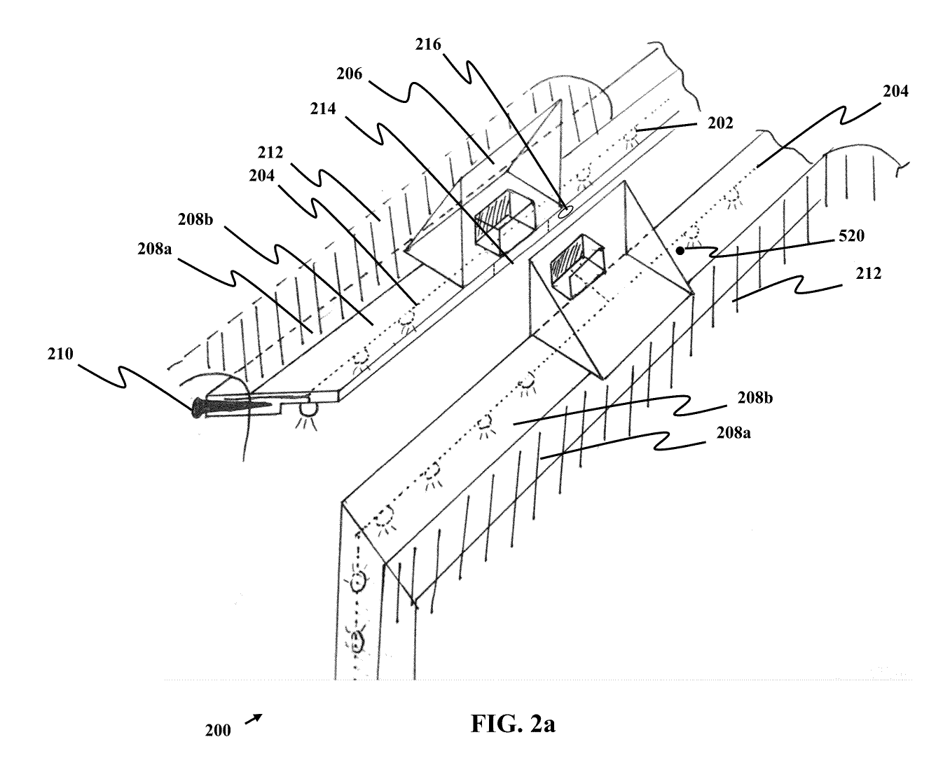

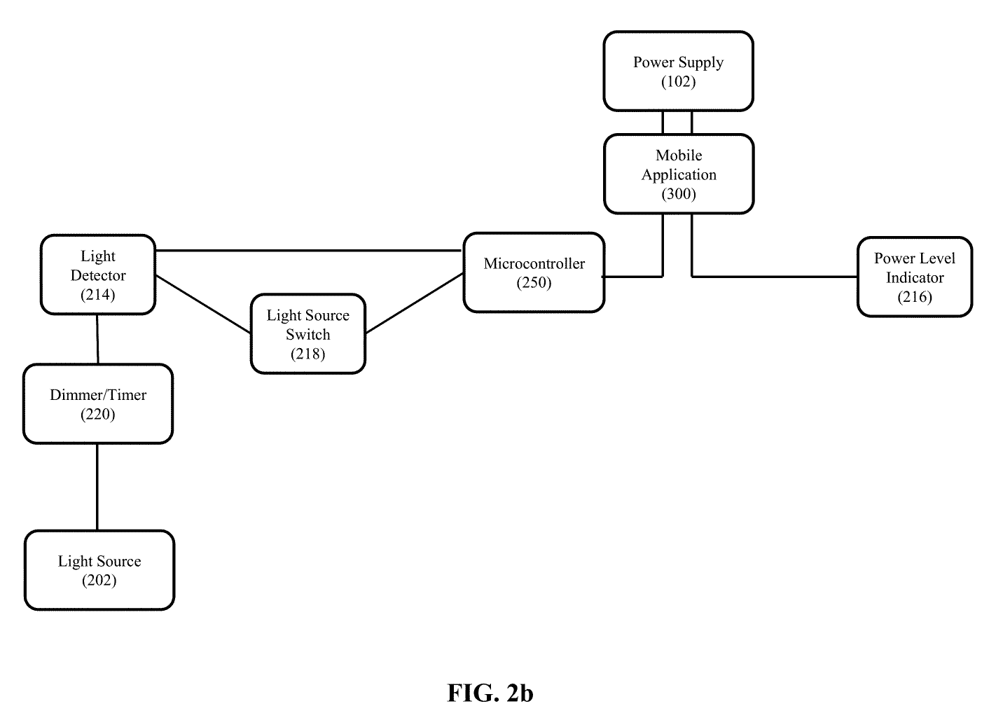

FIG. 1b is a side view of a portable power container as illustrated in FIG. 1a, according to some embodiments. FIG. 1b includes a portable power container 100, power supply or source 102, cords 104a and 104b, compartment 108, compartments 110a and 110b dedicated for portable electronic devices, portable electronic devices 112a and 112b, handles 118a and 118b, lining 120, main compartment 122, lighting frame 200, contactless connector 522, circuit board 526, and protective base 700. Lighting frame 200 includes a power supply 102, light source 202, an electrical distribution system 204, and a mechanical or magnetic latch and/or lock mechanism 206 electrically or magnetically connected to the power supply, light detector 214 (illustrated in FIG. 2a), and a power level indicator 216. FIG. 1b shows the portable power container 100 with lighting frame 200 open with light source 202 turned on.

Electrical distribution system 204 embodies the wires that connect light source 202 to the power supply or source 102, as well as the wires that electrically or magnetically connect a mechanical or magnetic latch, lock mechanism 206 to the power supply 102. Power supply 102 powers light source 202 via the wires of electrical distribution system 204 when portable power container 100 is opened and the opposing components that make up the mechanical or magnetic latch and/or lock mechanism 206 are separated. When the opposing components are brought together and the mechanical or magnetic latch, lock mechanism 206 is closed, power supply 102 ceases to send electrical current through electrical distribution system 204 and no longer powers light source 202. Regardless of the type of power supply employed, light source 204 can function in the same way.

The use cases of a self-lighting portable power container 100 are many, whether portable power container 100 is made with a light source switch 218 (illustrated in FIG. 2b) or automatically self-illuminates when the container is opened. It is especially useful when a user is attempting to find something in a dark environment. Such situations include a user looking for car keys in a dark parking lot, or similarly for house keys outside the home; looking for a ticket in a dark movie theater or concert hall; looking for makeup in a dimly lit restaurant or bar, or similarly for a credit card or form of identification; or looking for a phone or any other item in a situation in which ambient lighting is limited. The portable power supply 102 in the portable power container 100 makes this light source possible by supplying power to turn on the lights, but the system can also be powered by another independently integrated power source, such as a coin cell battery.

Light source 202 can be an LED, but is not limited to this embodiment. Other light sources include glow-in-the-dark tubes, glow-in-the-dark fabric, luminescent fabric, organic LED, SMD LED, fluorescent light, incandescent bulbs, high-intensity discharge bulbs, metal halide, high-pressure sodium, low-pressure sodium, mercury vapor, electroluminescent light, polymer light-emitting diodes, solid-state lighting, light-emitting electrochemical cells, electroluminescent sheets, electroluminescent wires, field-induced polymer electroluminescent technology, chemiluminescence, phosphorescence, Bose-Einstein condensate, X-ray light, free electron lasers, ERL, storage ring light source, laser light, electron stimulated cathodoluminescence, cathode ray tube, electron stimulated luminescence, gas discharge light, induction lighting, fluorescent light, compact fluorescent light, black light, hollow cathode light, excimer light, neon and argon light, dekatron, nixie tube, plasma light, xenon flash light, monopolar cyclic light, infrared light, UV light, entangled light emitting diode, high-intensity discharge light, carbon arc light, ceramic discharge metal halide light, hydrargyrum medium-arc iodide light, mercury-vapor light, metal halide light, sodium vapor light, sulfur light, xenon arc light, Nepal tube light, quantum dots, and diodes.

In some embodiments, the use of an LED light source is advantageous because of its brightness, long life span, durability, and great amount of light for a limited power draw, which aids in allowing the power source to be used to power portable devices in addition to the light source.

In the same way, light source 200 can be any self-lighting container. The embodiment depicted is a metallic doctor's frame because it adds structure to portable power container 100, can easily be integrated with any light source 200 (and is well suited for LED integration), can seamlessly house electrical distribution system 204, and allows for the stable integration of latch 206 and light detector 214.

FIG. 1c depicts a closed version of the portable power container illustrated in FIG. 1b, according to some embodiments. FIG. 1c shows the lighting frame 200 closed and light source 202 turned off. FIG. 1c includes portable power container 100, power supply or source 102, cords 104a and 104b for connecting the power supply to a mobile device, compartment 108 for power source and cords, compartments 110a and 110b dedicated to portable electronic devices 112a and 112b, power supply cartridge 114, handles 118a and 118b, lining 120, main compartment 122, light source 202, electrical distribution system 204, mechanical or magnetic latch, lock mechanism 206 electrically connected to the power supply, light detector 214, power level indicator 216, contactless connector 522, laser-etched tag 514, circuit board 526, item association indicator 520, pressure sensor 512, and biometric identifier 500.

FIG. 1d is a front view of compartment 108, encompassed in the lower portion of portable power container 100. FIG. 1d shows the power supply 102 in compartment 108. A mechanism 116 is used for keeping the power supply in place and for removing the power supply. Mechanism 116 can be a strap or tray and can be controlled mechanically or electrically. FIG. 1d includes power supply or source 102, perforated flap 106 for closing power supply compartment 108, compartment 108 for power source and cords, power supply cartridge 114a, mechanism 116, and protective base 700. Power supply 102 can be stored in compartment 108 and then accessed by a user through an opening sealable by flap 106. When the user opens flap 106, power supply 102 can be moved out of compartment 108 by mechanism 116, which can be, for example, a leather strap wrapped around power supply 102 or a tray holding the power supply 102 that can be pulled out mechanically or via an electrical connection. This system allows the user to replace power supply cartridge 114a and return power supply 102 to its original position.

FIG. 1e is a side view of the compartment illustrated in FIG. 1d, with the perforated flap 106 opened and the power supply 102 removed from compartment 108. Mechanism 116, encompassed in the lower portion of 100, is released allowing the power supply to be removed. FIG. 1e includes power supply or source 102, cord 104 connecting the power supply to a portable electronic device, perforated flap 106 for closing the power supply compartment, compartment 108 for power source and cords, mechanism 116 for removing power supply 102 to replace power supply cartridge 114a, and protective base 700. It shows that the user can access power supply 102 by opening perforated flap 106 and using mechanism 116 to pull power supply 102 out of compartment 108 for ease of replacing power cartridge 114a. Power supply 102 has cords 104a and 104b connected to it, but these cords can be integrated into the lining 120 of portable power container 100 so that they are not easily seen by the user. In addition, mechanism 116 for removing power supply 102 can allow for cords 104a and 104b to move in sync with power supply 102 and hence not become disconnected from the power source. This allows for the seamless integration of the power supply or source into portable power container 100 and the ease of use of the portable power container with respect to the integrated power supply 102 and the replacement of power supply cartridge 114a.

FIG. 2a shows the lighting frame 200 that is the light-integrated hardware of portable power container 100 to provide illumination when the container is opened, according to certain embodiments. FIG. 2a includes light source 202, electrical distribution system 204, mechanical or magnetic latch, lock mechanism 206 that is electrically connected to the power supply, frame 208a and 208b, mechanical component 210 connecting 208a and 208b, material 212, light detector 214, and power level indicator 216. Light source 202 is installed and embedded along the frame 208. A mechanical component 210 connects the two parts of the frame 208a and 208b while clasping the material 212 that forms the outside surface of portable power container 100.

Power supply 102 powers light source 202 via the wires of electrical distribution system 204 when portable power container 100 is opened and light detector 214 determines there is not enough ambient light to see within main compartment 122. Power supply 102 is activated when latch 206 is opened or separated. Power level indicator 216 continuously communicates with power supply 102 and displays the level of power left in the source via color coded light sources. When latch 206 is closed, the electrical signal to power supply 102 via electrical distribution system 204 ceases and light source 202 turn off.

FIG. 2b is a system diagram illustrating the components used for controlling the lighting frame 200, according to some embodiments. FIG. 2b includes power supply 102, mobile application 300, light source 202, control circuit 250, light detector 214, power level indicator 216, light source switch 218, and dimmer/timer 220. Power level indicator 216 reads the power level of power supply 102 and translates this into a visual signal via a colored light source. Mechanical or magnetic latch and/or lock mechanism 206, which can be embedded into the closure of frame parts 208a and 208b, can trigger the control circuit 250 to activate when portable power container 100 is opened; and transmit an electrical signal from power supply 102 to light detector 214, which either overrides the signal to turn on lighting frame 200 (by determining that there is ample light in the surrounding space) or allows the signal to pass through to light source 202. Light source 202 can also be controlled by dimmer/timer 220, via control circuit 250, which allows the light sources to remain on for a specific amount of time. Dimmer/timer 220 is in turn controlled by control circuit 250. Dimmer/timer 220 can be adjusted via a control circuit 250 to allow for specified periods of time that light source 202 remains lit when 100 is opened or how brightly the light source 202 shines pending light detector 214, for example. Light source switch 218 can override the electrical signal to the light detector and shut off the frame 200 even when it is opened This can also be controlled via the computerized method.

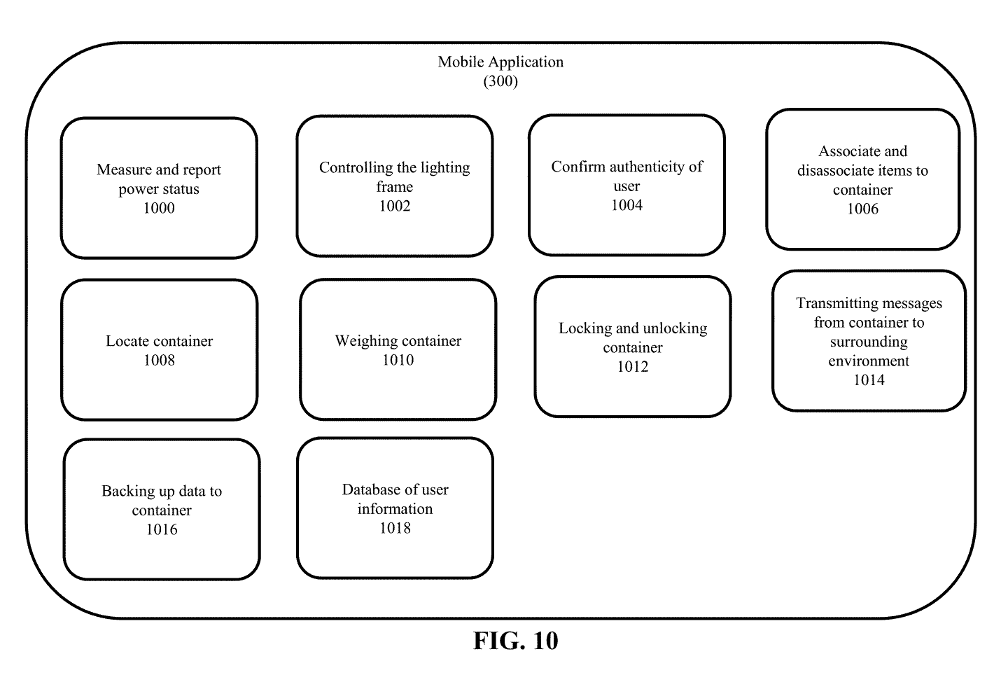

FIG. 10 is a diagram illustrating the multiple functions of a mobile application 300 for measuring and reporting power status 1000, controlling the lighting frame 1002, confirming authenticity of user for specific actions 1004, associating and disassociating items 1006, locating the container 1008, weighing the container 1010, locking and unlocking the container 1012, transmitting messages from the container to surrounding environment 1014, backing up of the data to the container 1016, and maintaining a database of user information 1018, according to some embodiments. Mobile application 300 acts to interface any and all technological integrations within the container to the user.

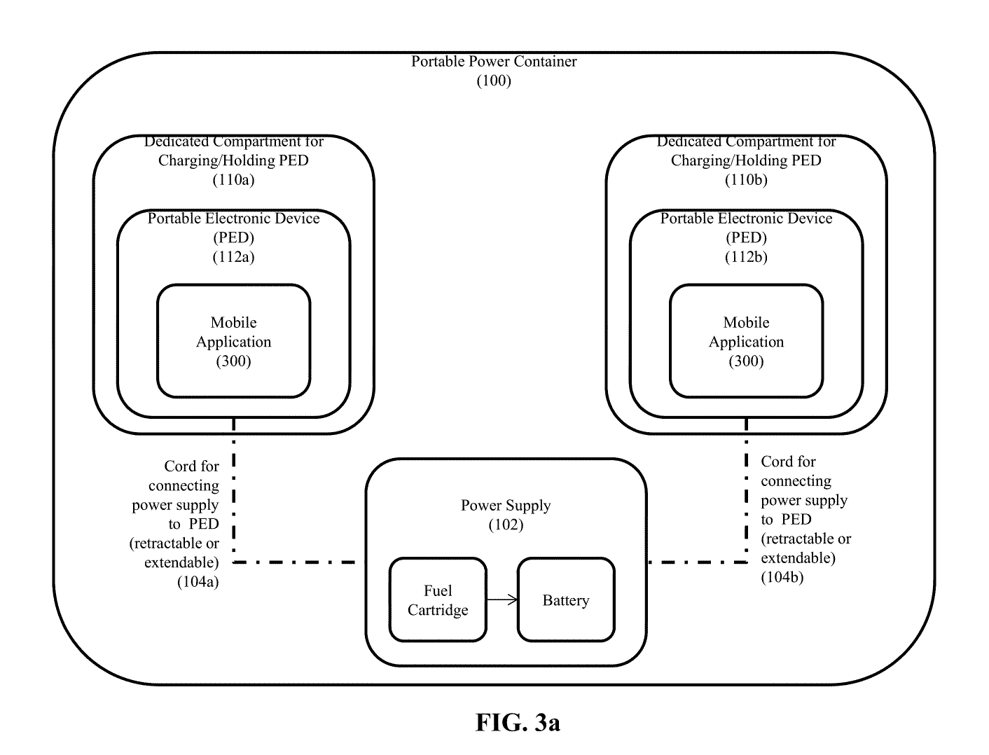

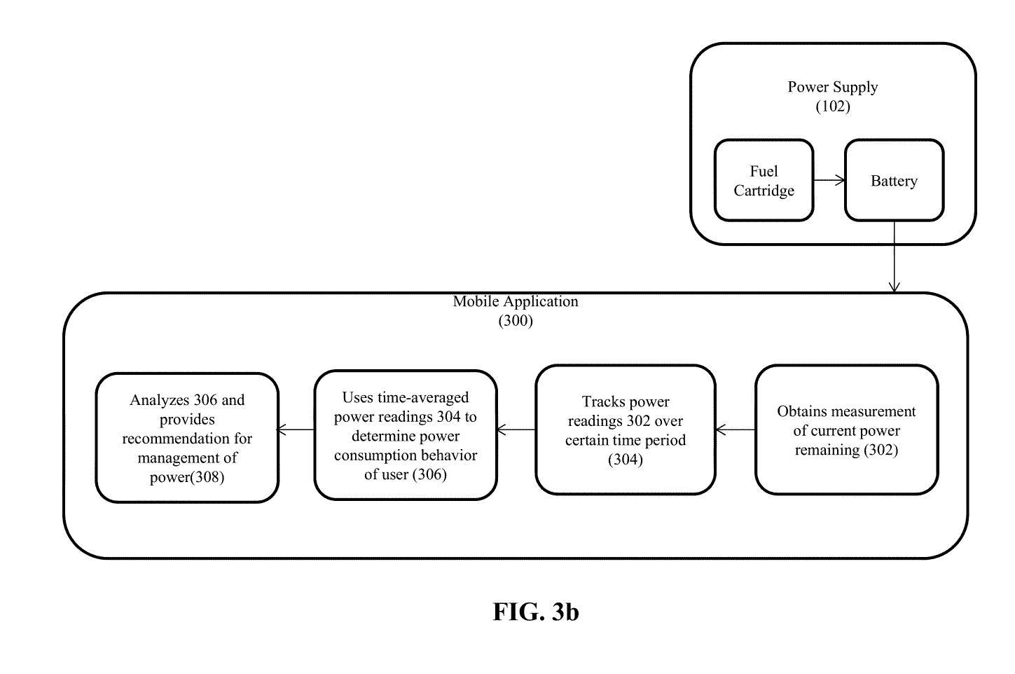

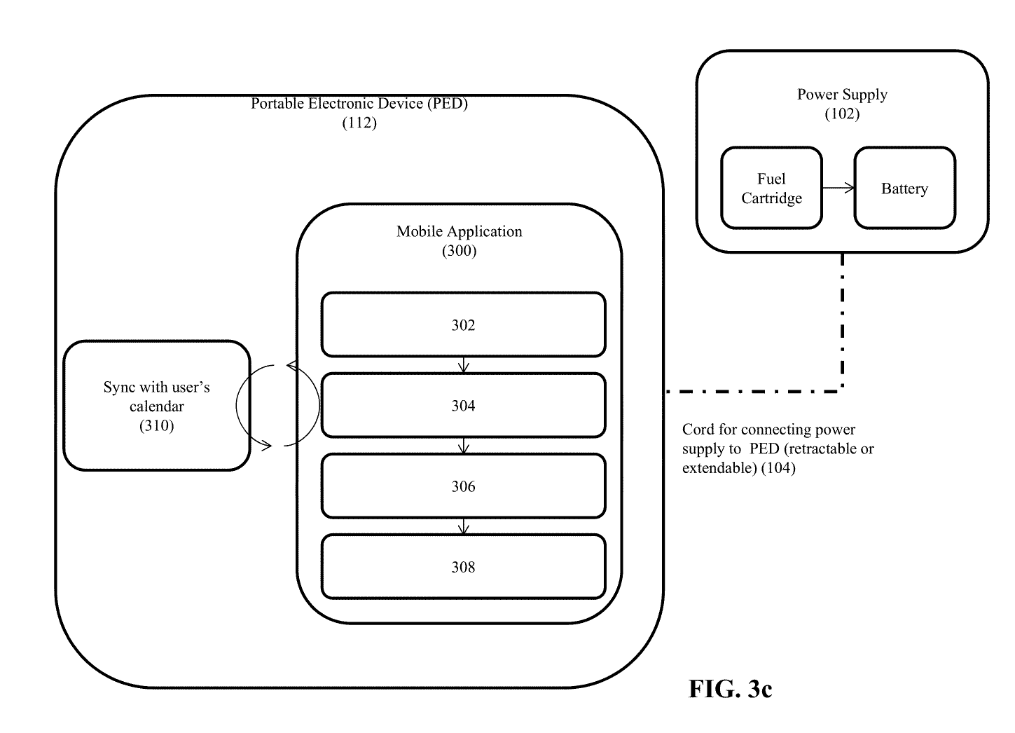

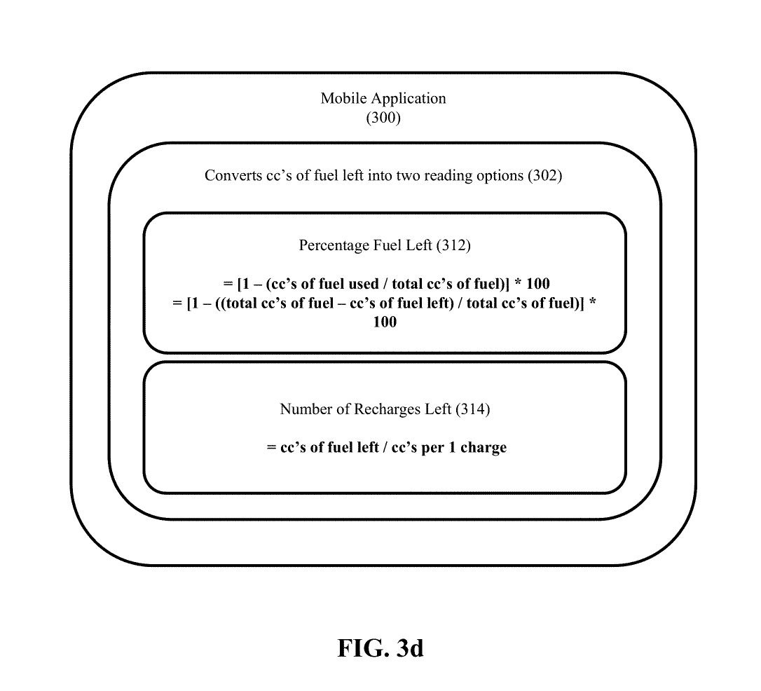

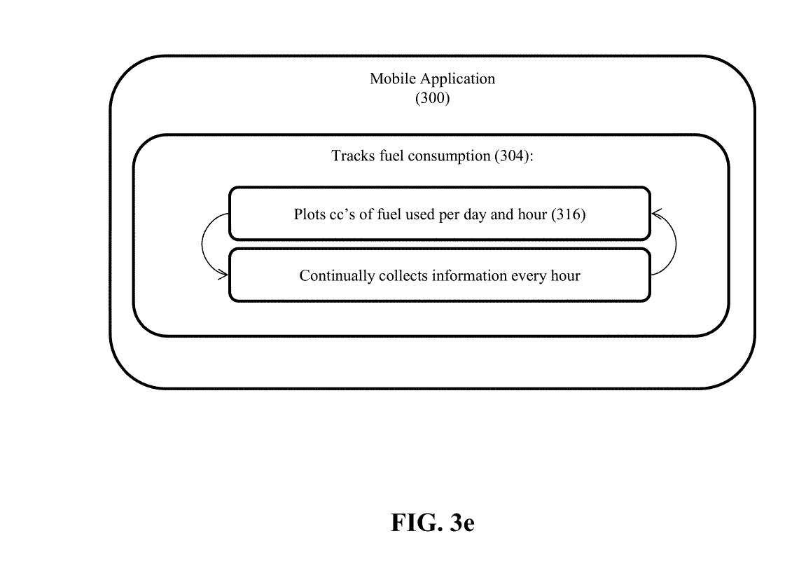

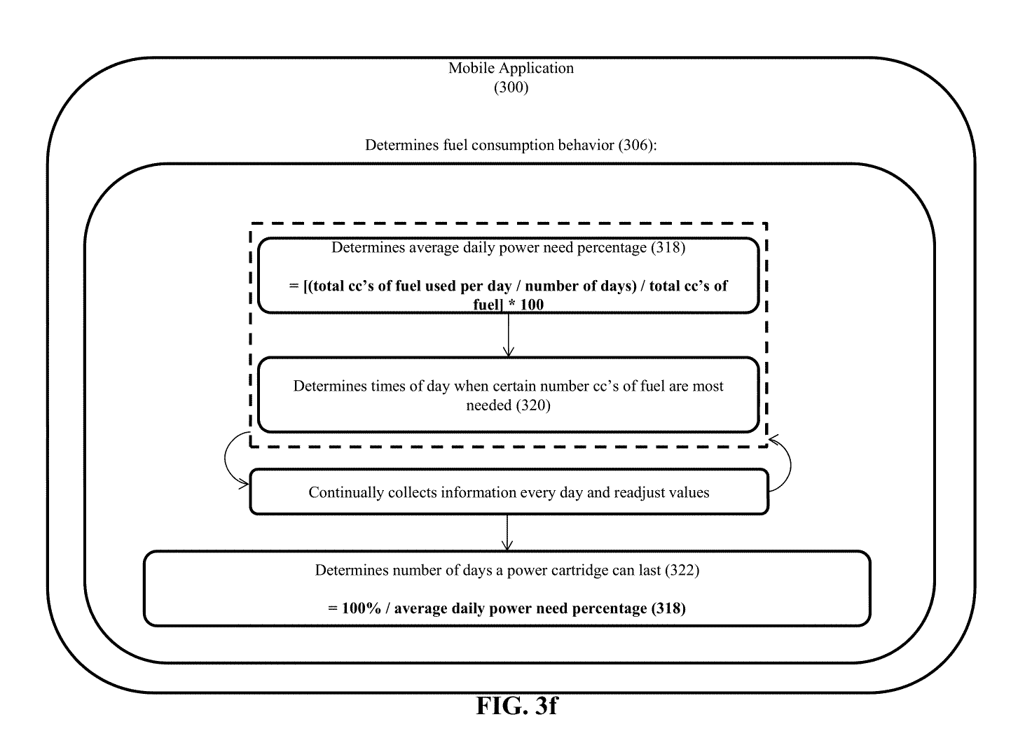

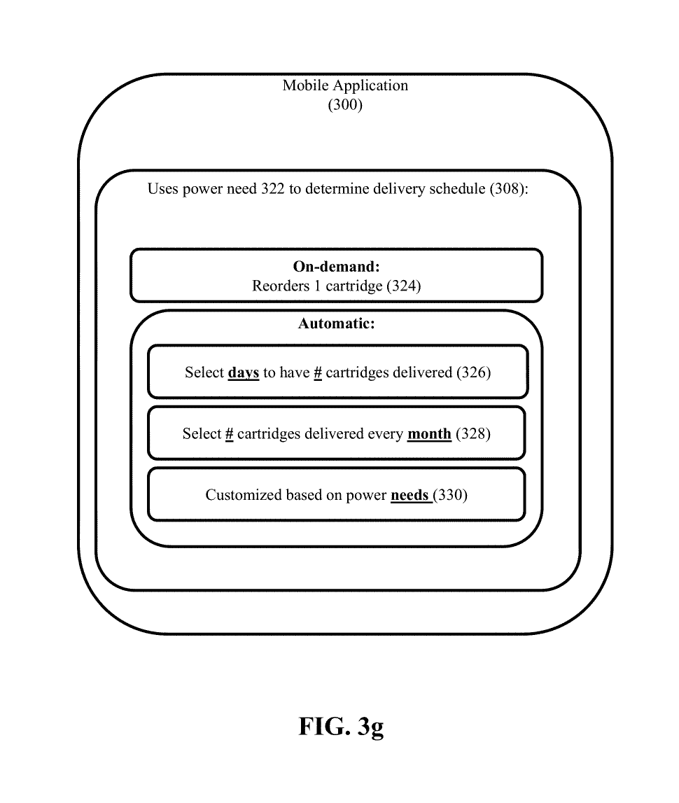

FIG. 3a is a hardware/software diagram showing the interaction between power supply or source 102, portable electronic devices 112a and 112b in dedicated charging/holding compartments 110a and 110b, respectively, the cords 104a and 104b that connect power supply 102 to portable electronic devices 112a and 112b, and mobile application 300 for measuring and reporting power status according to some embodiments. Portable power container 100 houses both power supply 102 and portable electronic devices 112a and 112b. Cords 104a and 104b connect portable electronic devices 112a and 112b to power supply 102, and rest in compartments 110a and 110b, respectively. When portable electronic devices 112a and 112b are connected to power supply 102 via cords 104a and 104b, mobile application 300 is activated and continuously gathers data via a signal from power supply 102. Mobile application 300 may be deactivated when cords 104a and/or 104b are disconnected from portable electronic devices 112a and/or 112b, or from power supply 102. The purpose of the mobile application 300 is to determine the power left in power supply 102, to learn the power consumption behavior of the user over time, and to recommend best power management practices, depending on power source. In embodiments where the power supply 102 employs inductive coupling, this information could be collected wirelessly from the mobile devices. In addition, detection of the device via and ID chip or WPAN combined with information about power consumption could be used to turn inductive charging on and off so that even if the device is in close proximity to the charging base, it does not charge unless consistent with the user's power management practices.

FIG. 3b is a flow chart illustrating the main steps of a mobile application 300 for measuring and reporting power status, according to some embodiments. At step 302, the mobile device obtains a measurement of the current power remaining in power supply 102 and causes that information to be displayed on portable electronic device 112. At step 304, the mobile device tracks the power level of power supply 102 over a certain time period and causes that information to be displayed on portable electronic device 112. Based on the information gathered at step 304, step 306 determines how much power the user consumes. Step 308 analyzes the information determined at step 306 and recommends best practices for the management of power. If power supply 102 is a fuel cell, for example, step 308 can recommend the number of power supply cartridges 114 needed to meet the power consumption needs of the user. If power supply 102 is a lithium-ion rechargeable battery, 308 can recommend the best times to power up, depending on the user's power-usage patterns. For example, if a user is known to more rapidly deplete power source 102 after 5 p.m., then step 308 can recommend the user power up at a time before and close to then.

FIG. 3c is a flow chart diagramming the interaction between power supply or source 102, portable electronic devices 112, the cords 104 that connects power supply 102 to portable electronic devices 112, mobile application 300 for measuring and reporting power status, and its component steps 302, 304, 306, 308, and 310, and a user's calendar, according to some embodiments. When mobile application 300 is set to sync with a user's calendar, step 310, step 308 can also recommend power-up times based on activities. For example, if a user has a video conference call on the device scheduled for one hour at 10 a.m., step 308 can recommend the user have a certain minimum power level to uphold the activity. If the power level is below the threshold used to uphold the activity, step 308 can recommend to power up for an exact amount of time in order to reach that minimum power level.

If too little power consumption data is collected from the user to personalize a recommendation 308 (as would be the case when a user is new), step 308 can use outside data sources to recommend best power management practices. Shim, J. P., S. Park, J. M. Shim. 2008, Mobile TV phone: current usage, issues, and strategic implications. Indust. Management and Data Systems 108(9) 1269-1282, incorporated by reference herein, found that the highest usage of smartphones occurs between 6 and 9 a.m. and 6 and 8 p.m., which is consistent with the notion that most users view content using mobile phones while commuting from home to work and back. For example, step 308 can recommend a user powers up for one hour, at least half an hour before commuting in order to have enough power to use the device during the commute. More broadly, step 308 could use outside data to understand the average increase in mobile device usage during specific seasons or holidays, like Christmas, when users are increasingly using devices for online shopping; and hence recommend a minimum power level to maintain throughout the day in order to accommodate for the extra usage time.

FIG. 3d is a detailed flow chart illustrating step 302 of mobile application 300 when power supply or source 102 is a fuel cell, according to some embodiments. When mobile application 300 receives a signal from power supply 102, step 302 translates the signal into a measurement of the current power remaining. Step 302 may display the information using two readable measures: the percentage of power left within power supply 102 (element 312), and the number of recharges that one can still obtain with current power supply cartridge 114 (element 314). The mobile application can determine the percentage of power left within power supply 102 by dividing the number of cc's of fuel already used by the total number of cc's of fuel in power supply cartridge 114, subtracting that value from 1, and multiplying by 100. The number of cc's of fuel already used is calculated by subtracting the number of cc's left from the total number of cc's of fuel in power supply cartridge 114. The mobile application can determine the number of recharges that one can still obtain with current power supply cartridge 114 by dividing the number of cc's of fuel left by the number of cc's needed per one full charge.

As an example, we can assume power supply cartridge 114 holds 50 cc's of liquid, and that an average smartphone requires 5 cc's of liquid to charge from 0-100%. Power supply cartridge 114 can therefore provide ten full charges. Further, we can assume that 10 cc's of liquid have already been used. The mobile application would present a value of 80% for the percentage of power left within power supply 102 (i.e., 100*[1−((50−40)/50)]) and 8 for the number of recharges remaining (i.e., 40/5).

FIG. 3e is a detailed flow chart illustrating step 304 of mobile application 300 when power supply or source 102 is a fuel cell, according to some embodiments. The mobile application 300 maintains a list of the data points displayed by step 302 over each hour of each day (step 316). The mobile application 300 can determine the list of the data points displayed by step 302 by continually plotting the number of cc's of fuel used by hour for each day for a week. For example, over one week, step 316 can collect 168 readings.

To continue the previous example, we can assume the following simple behavior of a user: from Monday to Friday, 5 cc's of fuel are used between 6 a.m. and 7 a.m.; on Saturday, 2 cc's of fuel are used between 1 p.m. and 2 p.m., 2 cc's of fuel between 5 p.m. and 6 p.m. and 4 cc's of fuel between 10 p.m. and 11 p.m.; and on Sunday, 4 cc's of fuel between 5 p.m. and 6 p.m. In step 316, the mobile application would plot those data points.

FIG. 3f is a detailed flow chart illustrating step 306 of mobile application 300 when power supply or source 102 is a fuel cell, according to some embodiments. Over time, the mobile application determines the user's behavior of fuel consumption by creating a daily average for how much power was used (step 318). This is done so as to create a more accurate representation of the power needed by the user. The mobile application also determines what times during the day fuel is most needed by the user in step 320. The mobile application determines the daily average for how much power was used in step 318 by adding up the total number of cc's of fuel used each day and dividing by the number of days for which data has been collected. It determines what times during the day fuel is most needed by the user in step 320 by overlaying the data collected by step 316 and determining high density areas on the graph. The mobile application continually collects data over each day and readjusts these values after the data has been collected. In step 322, after the daily average for how much power was used has been updated, the number of days a power cartridge can last is determined by dividing the percentage of a full power supply cartridge 114 (100%) by the average daily power need percentage determined in step 318.

Using the previous example, the daily average for how much power was used may have a value of 5.3%, i.e., the amount of power that is needed per day, on average (100*[((5+5+5+5+5+2+2+4+4)/7)/50]). The times during the day fuel is most needed by the user 320 may be, for example, Mondays-Fridays between 6 a.m. and 7 a.m., and some power on weekends between 5 p.m. and 6 p.m. With this behavior, the number of days a power cartridge can last may be, for example, 18 days. (i.e., 100%/(5.3%/day)).

FIG. 3g is a detailed flow chart illustrating step 308 of mobile application 300 when power supply or source 102 is a fuel cell, according to some embodiments. Step 308 offers options for the purchase of power cartridges 114. A user can purchase power cartridges 114 on demand (step 324) or can set up automatic purchase options for power refill. A user can do this, for example, by either (a) specifically selecting the days on which he or she would like to receive a certain number of power cartridges (step 326); (b) selecting how many power cartridges 114 he or she would like delivered at the beginning of each month (step 328); or (c) allowing the system to select how many power cartridges 114 are needed based on the power need calculated at step 322 (step 330).

Continuing the previous example, if the user selects automatic delivery of power cartridges 114 based on power needs, mobile application 300 would automatically request delivery of one power cartridge every eighteen days. As the value estimated for the number of days a power cartridge can last (step 322) is updated over the time, the frequency with which power cartridges are delivered may increase or decrease, accordingly.

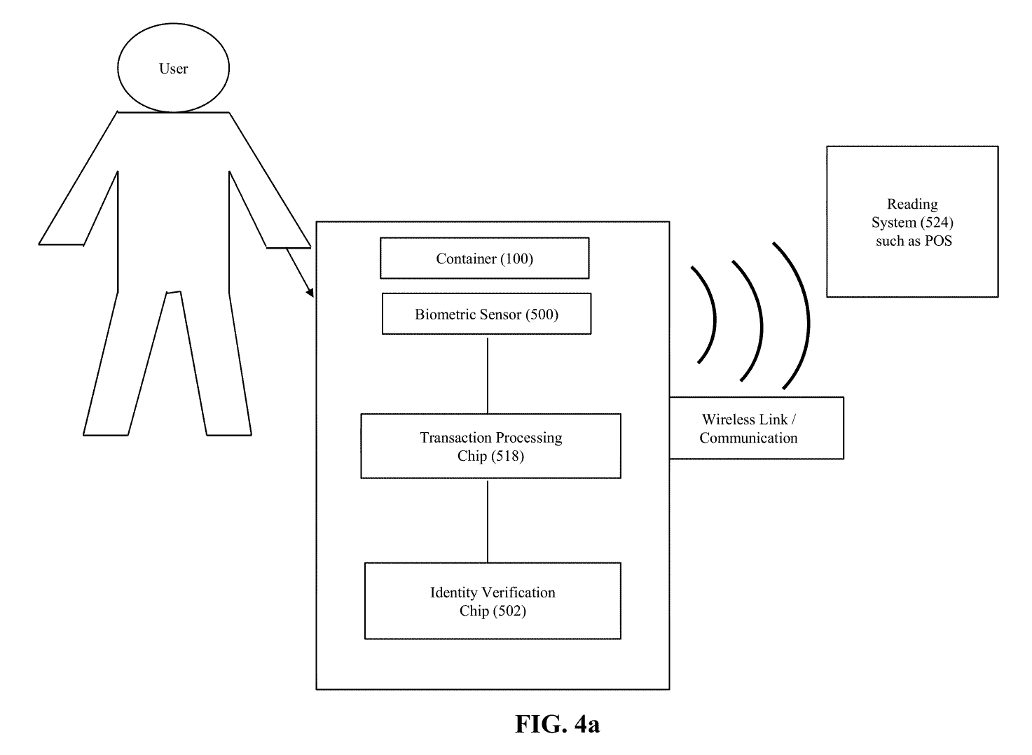

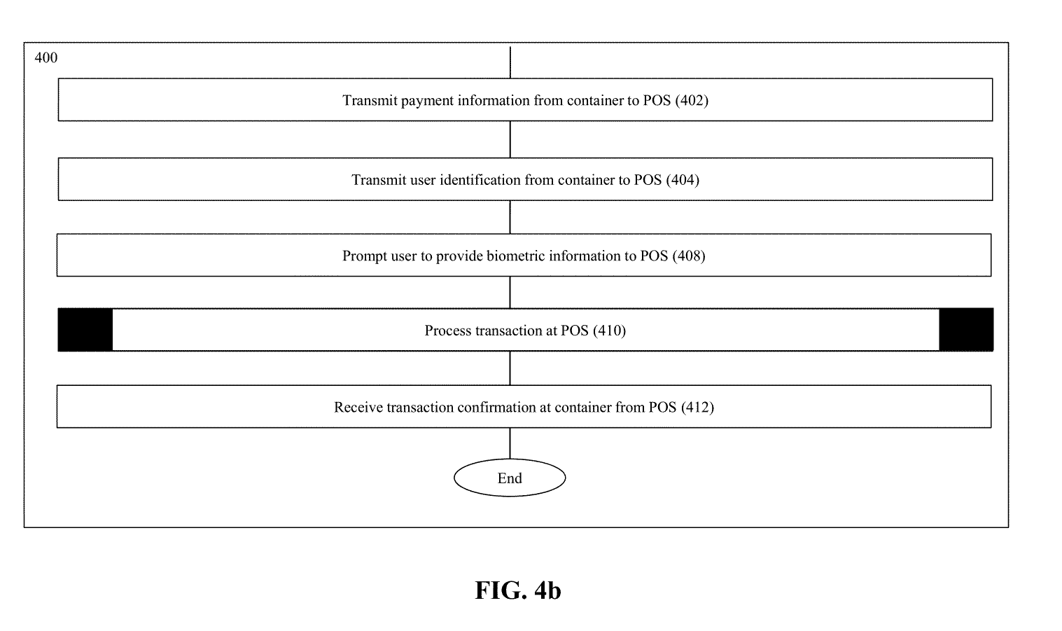

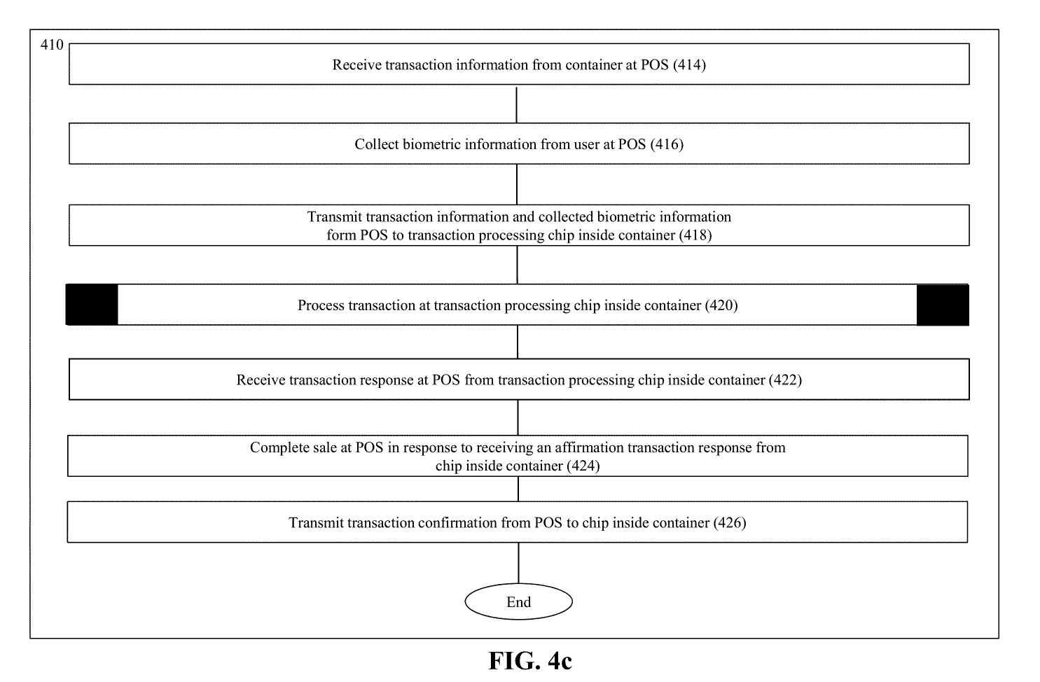

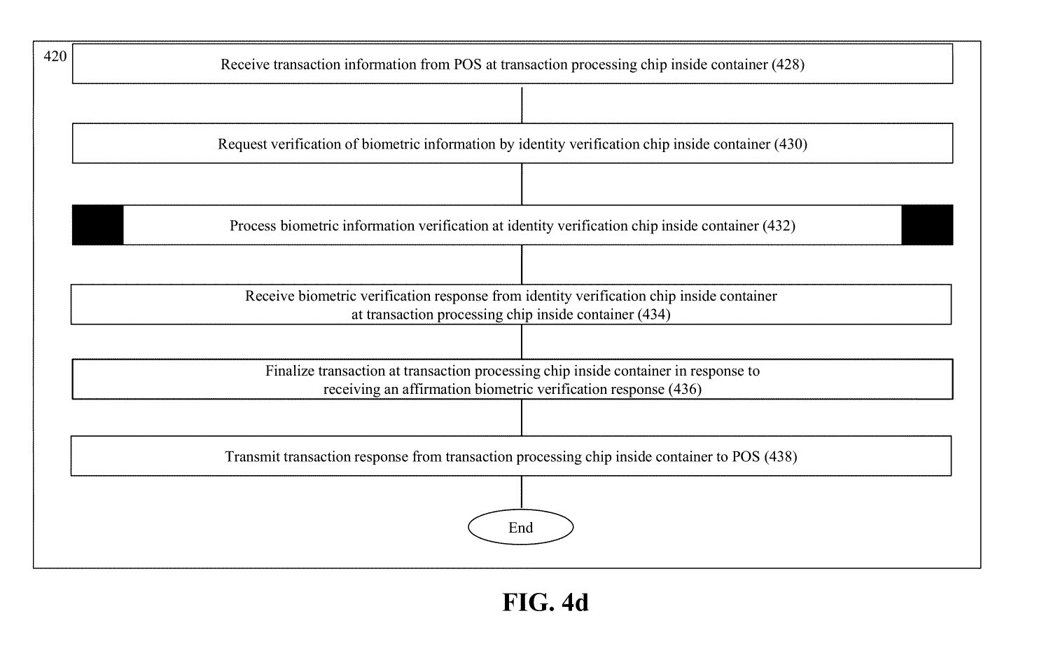

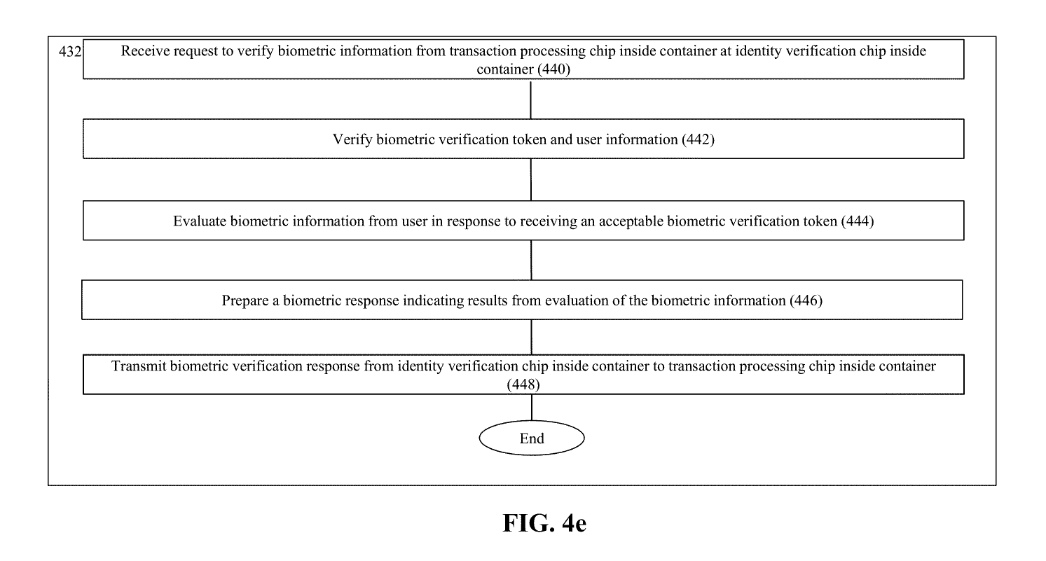

FIG. 4a is a high-level diagram depicting the interaction between a user's container and a reading system for an identification/authentication system, according to some embodiments. FIG. 4a includes portable carrying container 100, biometric sensor 500, transaction processing chip 518, ID verification chip 502, and reading system 524. Reading system 524 can be a merchant terminal, such as a POS, a locking/unlocking terminal, such as for cars, doors, etc., an automated teller or other banking machine, a check-in terminal, such as at a hotel or airport terminal, or any other server-based system that requires a secure identity check. When a user approaches a reading system 524, biometric sensor 500, transaction processing chip 518, and ID verification chip 502 all act together to confirm the user's identity and to complete the appropriate transaction.

FIG. 4b is a flow chart illustrating the general process by which a container transmits information to a reading system 400, according to some embodiments. In the first step 402, when a user is close enough to reading system 524, container 100 transmits user payment information stored on ID verification chip 502 to reading system 524. In the next step 404, user identification is transmitted from the container 100 to the reading system 524. In the next step 408, the user is prompted to provide biometric information, such as by scanning a fingerprint onto the container. The transaction is processed 410 and verification is sent by reading system 524 to container 100 to be stored in ID verification chip 502 in step 412. This system utilizes three pieces of data to securely complete a transaction: proximity to reader, identity of user, and verification of user via biometry.

The methods and systems described enable a user's container to generate and transmit a biometric verification response via the container to a reading system terminal, such as a POS system. For example, a user making a purchase that needs biometric verification can grant the POS system or associated server access to request a verification response of the user's biometric information for a set of transactions. The user granting permission to be identified by his or her biometric information for a specific transaction can allow the biometric information to be collected inside the container and have only a verified response sent over to the POS system. This biometric information may include, among other examples, information for facial recognition, voice print matching, galvanic skin response, or fingerprint analysis. A digital wallet or similar mechanism associated with the container may be used for payment or other transactions associated with the biometric verification. The biometric verification response may be passed to the POS system along with communication of the payment or other transaction information. Such verification can increase security for the transaction, as the POS or server does not directly access the biometric information of the user, but instead only accesses a response created through the container's own verification system.

A secure, verification chip inside the container may be accessed by the POS system, or the associated server, to request the verification of the biometric information collected from the user. The biometric verification token may be passed to the secure, verification chip inside the container to prove that the user has granted biometric verification privileges to the merchant. The authentication chip inside the handbag may only verify the biometric information to the merchant (POS system or server) if a valid biometric verification token is provided. The biometric verification token may be a single-use token authorizing the POS system to verify the user's biometric information as part of a current transaction.

FIG. 4c is a flow chart illustrating how a transaction is processed at the reading system 410, according to some embodiments. In the first step 414, reading system 524 receives the transaction information from container 100. In the next step 416, reading system 524 requests biometric information from user via container 100. In the next step 418, the reading system 524 transmits transaction information and collected biometric information from reading system 524 transaction processing chip 518 inside container 100. In the next step 420, transaction processing chip 518 processes the transaction inside the container 100. In the next step 422, the transaction processing chip 518 sends a transaction response to reading system 524. In the next step 424, reading system 524 reads the response and upon confirming its affirmation, completes the transaction. In the last step 426 reading system 524 transmits a transaction confirmation to ID verification chip 502 inside container 100.

FIG. 4d is a flow chart illustrating the container's internal transaction process 420, according to some embodiments. In the first step 428, the transaction processing chip 518 inside the container 100 receives transaction information from reading system 524 inside container 100. In the next step 430, the reading system 524 requests verification of the biometric information by identity verification from ID verification chip 502 inside container 100. In the next step 432, ID verification chip 502 processes the biometric information verification at ID verification chip 502 inside container 100. In the next step 434, the transaction processing chip 518 inside container 100 receives the biometric verification response from the ID verification chip 502 inside container 100. In the next step 436, the transaction processing chip 518 inside container 100 finalizes the transaction in response to receiving an affirmation biometric verification response. In the last step 438, transaction response is transmitted from the transaction processing chip 518 inside the container 100 to the reading system 524.

FIG. 4e is a flow chart illustrating how an ID verification chip 502 embedded within the container 100 verifies the user's biometric information 432, according to some embodiments. In the first step 440, ID verification chip 502 receives request to verify biometric information from the transaction processing chip 518 inside container 100. In the next step 442, the ID verification chip 502 verifies the biometric verification token and user information against the stored user information. In the next step 444, the ID verification chip 502 evaluates the biometric information from the user in response to receiving an acceptable biometric verification token. In the next step 446, the ID verification chip 502 prepares a biometric response indicating results from evaluation of the biometric information. In the last step 448, the ID verification chip 502 transmits the biometric verification response to the transaction processing chip 518 inside container 100.

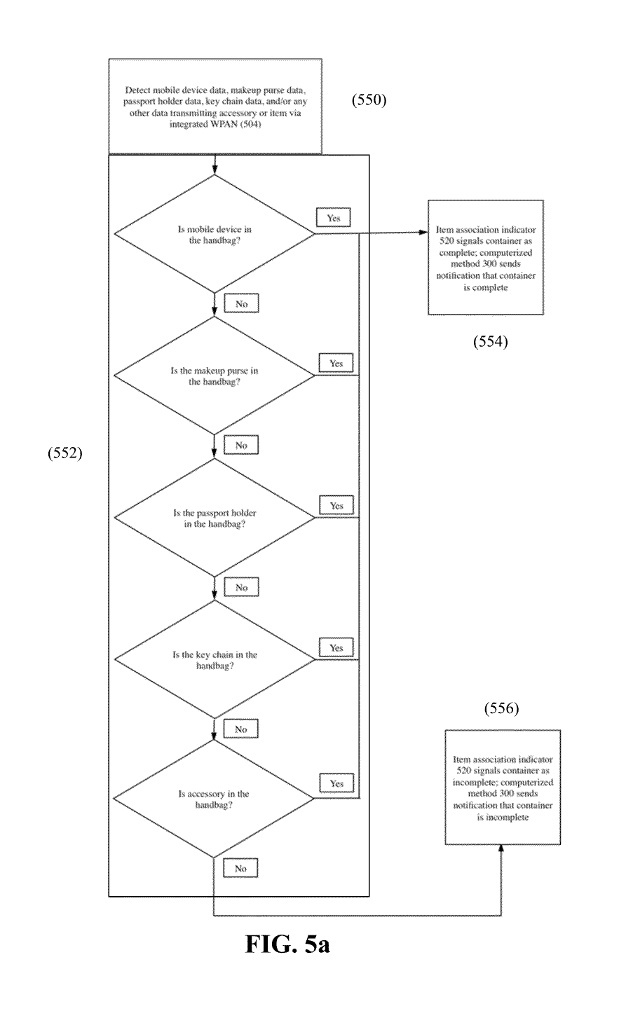

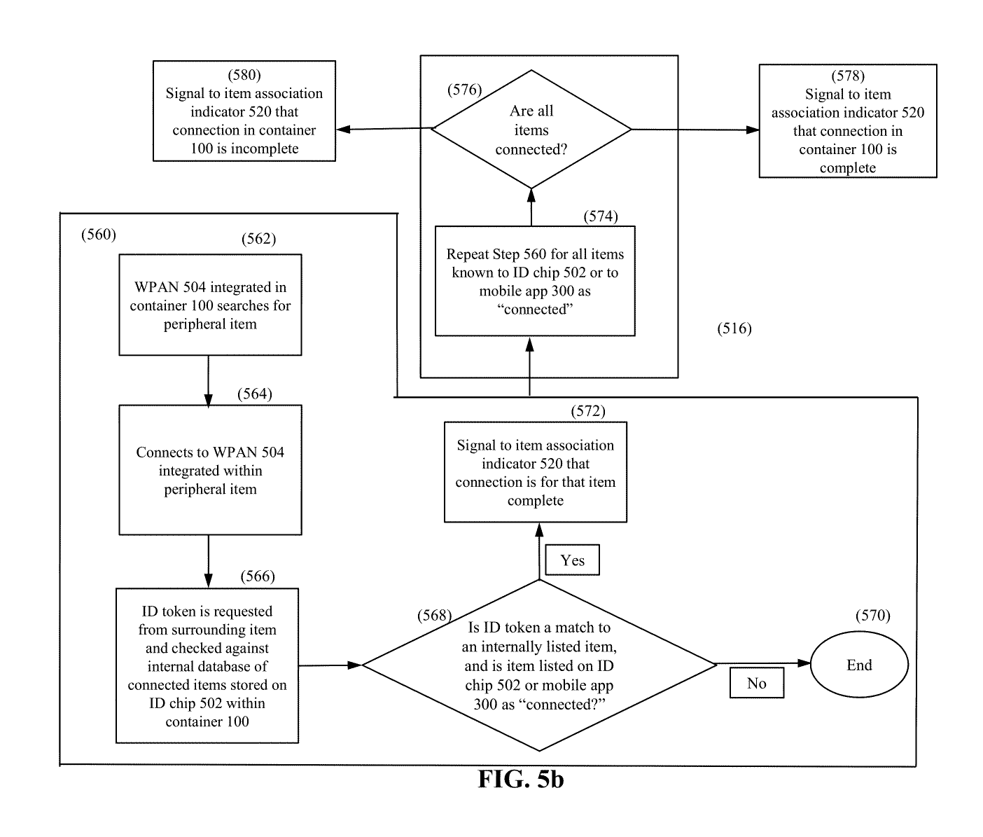

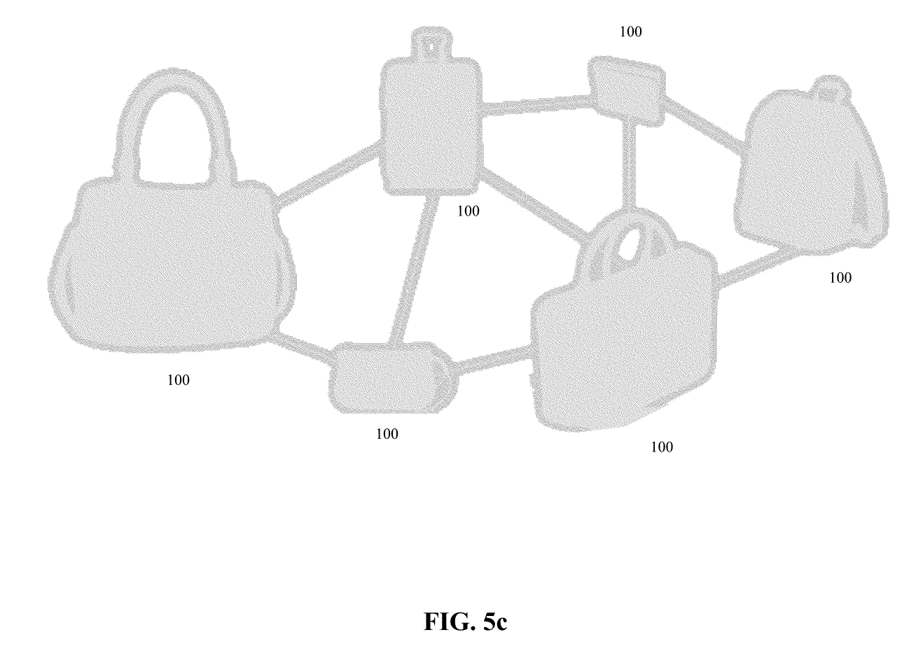

FIG. 5a is a high-level flow chart of how the container ensures it is connected to all the peripheral items that a user has chosen to connect to, according to some embodiments. In the first step 550, through an embedded communicative technology such as WPAN 504, container 100 detects whether a connection can be made with a peripheral item. In the next step 552, using the list of connected devices that a user has set via computerized method, for example mobile application 300, or online account, container 100 checks through each item to ensure its presence in the container 100. If all associated items are present, container 100 sends a signal to item association indicator 520 to signal that the container is complete in step 554. Computerized method also receives a message that container 100 is complete. If even one associated item is not present, step 556 is implemented in which item association indicator 520 signals that the container is incomplete. Computerized method also receives a message that container 100 is complete. Item association indicator 520 can be an embedded visual, aural, or tactile signal, such as LED, a soft beep, or a vibration. Computerized method, for example mobile application 300, allows a user to associate and disassociate items carried by the container.

FIG. 5b is a detailed flow chart illustrating how the container identifies the associated items, according to some embodiments. First in step 562, WPAN 504 integrated in container 100 searches for peripheral item. Next in step 564, container 100 connects to WPAN 504 integrated within the peripheral item. Once a connection is made between container 100 and peripheral item via WPAN 504, in step 566, ID verification chip 502 embedded within container 100 requests and receives an ID token from the peripheral item and cross-checks it with the internal database of associated items. Next in step 568, it is determined if the ID token is a match to an internally listed item, and if the item is listed on ID verification chip 502 or mobile application 300 as “connected.” Only if the token matches a listed item to be associated and that item is listed as one of the connected items does the process proceed to step 572 and the connection for the item complete, and item association indicator receives a signal for that item. If the two conditions for identification and association are not met, the process proceeds to step 570 and the item is deemed to be a disassociated item. A disassociated item is one that is recognized by the container but is not needed to be connected based on preferences set via mobile application 300 or online account. In step 574 the process 560 is repeated for all items known to ID verification chip 502 or to mobile application 300 as “connected.” Once the process 560 is complete for all connected items the process proceeds to step 576 and determines if all items are connected. If all items are connected the process proceeds to step 578 and signals to item association indicator 576 that connection in container 100 is complete. If all items are not connected the process proceeds to step 580 and signals to item association indicator 576 that connection in container 100 is incomplete.

In some embodiments, if a device 112 is associated with the container 100, then mobile application 300 can infer via the proximity of device 112 to container 100 using communicative technologies as well as via the associated and disassociated items what information from the user's device is the most powerful and useful. For example, if a user's device is near the container, then computerized method will push more work-related information such as emails, calendar invites, meetings, etc. if said container is primarily used for work. Similarly, it will push travel updates, weather conditions, hotel information if said container is used primarily for travel. If a user's container is associated with sunglasses, tanning lotion, and a tablet, for example, mobile application 300 will push new music, promotions at coffee or ice cream shops, and local events happening, as it will understand the container is primarily being used as a beach bag. In this case, the container acts a hub and begins to understand the purpose of the user's intentions and actions with the container. Using all the information collected, computerized method begins to learn the user and thereby understand which container is used for travel, which is used for dinners, etc. and push the appropriate information to the user thereon.

FIG. 5c is a diagram exemplifying various embodiments of portable carrying container and the interconnectivity between the containers facilitated by various embedded communicating technologies, according to some embodiments. In this example, only embodiments of container 100 are connected to each other: backpack, clutch, luggage, wallet, briefcase; but these items can be other object such as devices, shoes, luggage tags, makeup purses, key chains, bookmarks, etc. The connecting technology can be as simple as a passive RFID sticker, which can be placed even within or on items such as books, sunglasses cases, charging cables for laptops and devices, and other items that a user wishes to port within a carrying container or along within him or her, personally. This is especially useful for young students, to help parents ensure that they are carrying with them the appropriate books and devices to school daily. A user can also use mobile application 300 to set the days or times during which certain items are associated or disassociated. Further, mobile application 300 can sync to the user's calendar application to anticipate the user's schedule. For example, a law student can be reminded to carry a Torts textbook only on days when “Torts” is scheduled, etc.

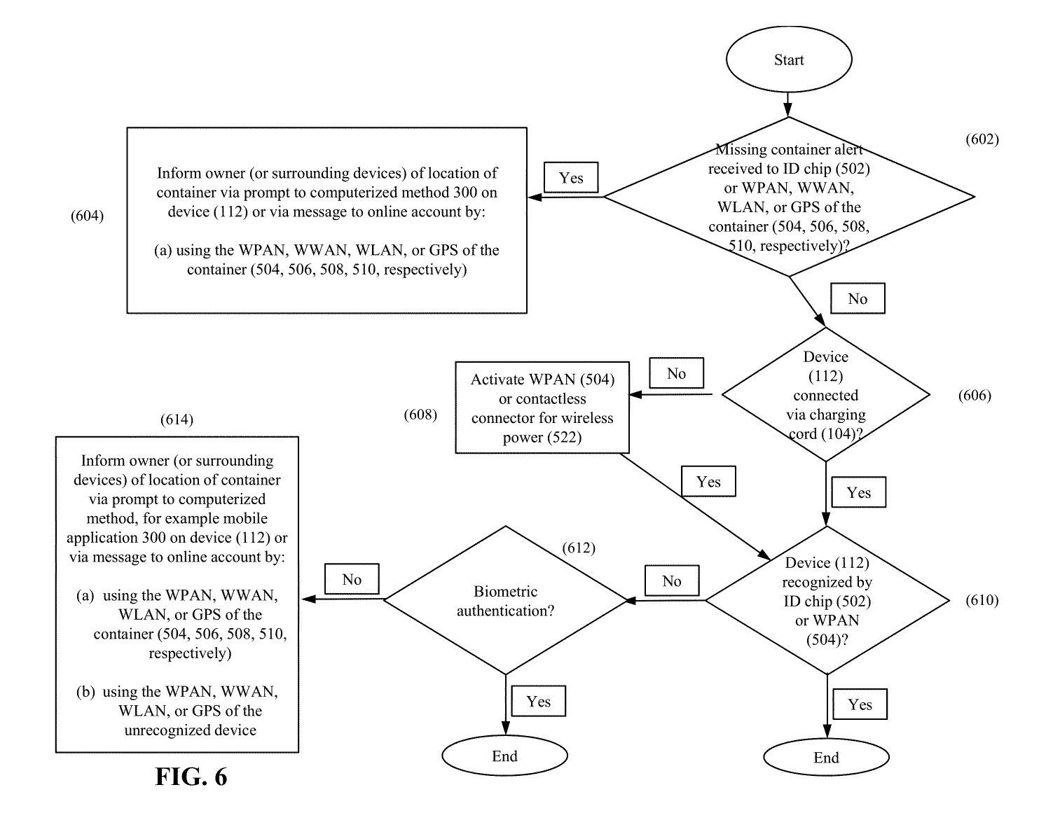

FIG. 6 is a flow chart illustrating the method by which a container can be located should it be stolen or go missing, according to some embodiments. FIG. 6 includes portable electronic devices 112, charging/holding compartments 110, cords 104 that connect power supply 102 to portable electronic devices 112, WPAN 504, contactless connector for wireless power 522, and a computerize method, for example, computerized method, according to some embodiments. In step 602, if container 100 receives notification via any of the communicative embedded technologies within the container that the container is missing, then in step 604, the owner of said container is immediately informed via a computerized method, for example mobile application 300 or via message to an online account. The notification such that container 100 is missing can be sent via computerized method or via online account by the owner. In some embodiments, the communicative embedded technologies within the container can connect to any open listening ports, such as to passerby devices, and notify those devices that said container 100 is missing.

If container 100 does not receive an alert from its owner that it is missing, then in step 606, the device 112 is checked to determine if it is connected via the charging cord. If the device is not connected via the charging cord the process proceeds to step 608 and it is determined if the device is connected via activate WPAN (504) or contactless connector for wireless power 522. If the device is connected via the charging cord then the process proceeds to step 610. If the device is connected via activate WPAN (504) or contactless connector for wireless power 522 the process also proceeds to step 610. In step 610 the device 112 is checked against the information residing on integrated ID verification chip 502 or via a linked WPAN network to confirm the device is registered with the container. When a device 112 is placed into the dedicated charging compartment 110 in order to power up (either via cord 104 or contactless connector for wireless power 522), then container 100 checks for a biometric token in step 612, as similarly described in FIG. 4. If the biometric authentication in step 610 is confirmed, unrecognized device 112 continues to power up. This would be the case if a user chooses to power up a device belonging to a colleague or friend, for example. If it is denied, the process proceeds to step 614 and the container 100 sends a message with attached location of the container to computerized method or to the user's online account that said container is missing. This can be completed via (a) any of the communicative embedded technologies within the container; or (b) any of the communicative embedded technologies within the unrecognized device. In some embodiments, the communicative embedded technologies within the container or unrecognized device can connect to any open listening ports, such as to passerby devices, and notify those devices that said container 100 is missing.

In some embodiments, container 100 will be integrated with a continuously communicative embedded location technology such as GPS 510 and hence allow container 100 to be tracked via a computerized method, for example mobile application 300, or the user's online account.

In some embodiments, the container will contain a laser-etched tag 514 placed anywhere within the container that is unobtrusive but still visible, such as on the bottom of the container. The laser etched tag will contain a unique serial number and a message saying, “If found, please register 0123-456-789 on jonlou.com,” for example. A finder of the container can then submit the serial number and online, which would communicate to the owner that the container has been located. The owner's account will prompt an option for the owner to submit contact information to the finder or to send a note to the finder, such as to ask the finder to leave the container at a certain address, for example. In this way, both the owner and finder can remain anonymous and safe, while still engaging in the return of a personal item. The owner of the container can register the container online at the point of sale, or later on via the online account.

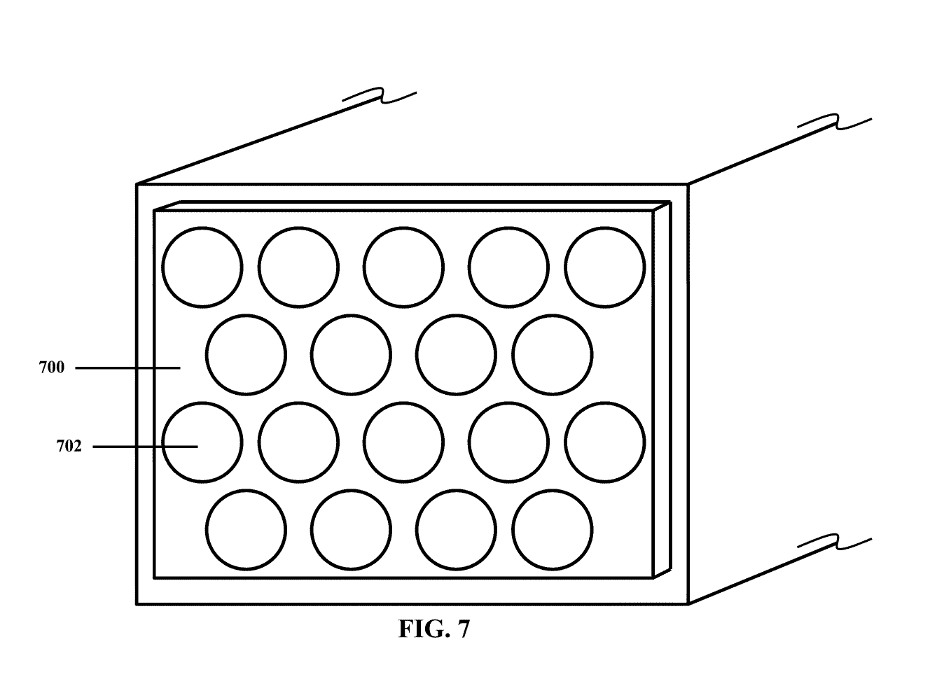

FIG. 7 depicts the protective base 700 installed on the exterior bottom of the portable power container 100, according to some embodiments. Protective base 700 is used to protect portable power container 100 from external elements such as moisture and dirt, as well as provide a buffer to impact for portable power container 100 and other electronics when portable power container 100 is placed, thrown, or falls onto the floor or ground. Hence, protective base 700 is composed of any material that can absorb shock and be cleaned, such as silicon or rubber. Protective base 700 can also be embossed with pattern 702 in order to create an extra layer of protection, so that the overall thickness of protective base 700 is increased, and a smaller surface area of the base interacts with the environment, so that cleaning is easier. Pattern 702 can be geometric or depict any image, such as a logo. Protective base 700 can be attached to the base of portable power container 100 via an adhesive or stitching.

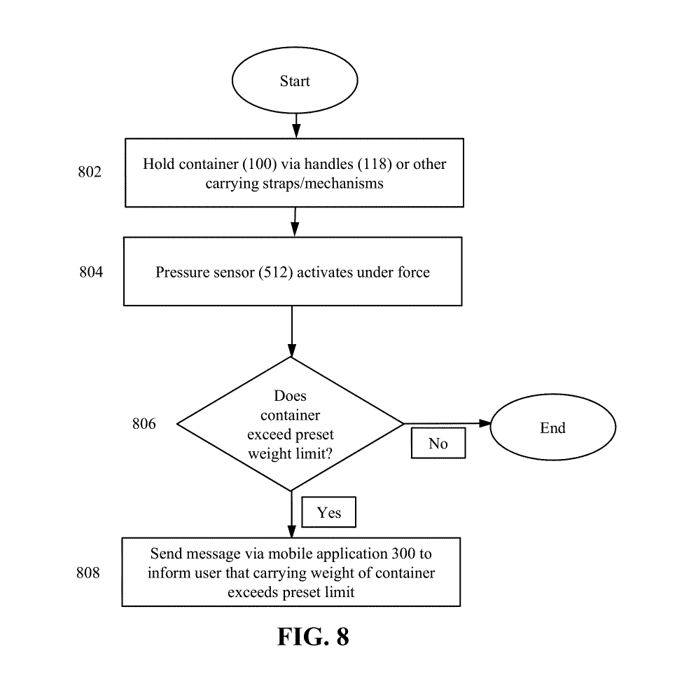

FIG. 8 is a flow chart illustrating how the embedded pressure sensor communicates to the user that the container is too heavy for carrying, according to some embodiments. FIG. 8 includes pressure sensor 512, handles 118, and container 100, according to some embodiments. Mobile application 300 can use be used to set a weight limit for the container. In step 802, when a user applies force to the pressure sensor, either by placing the container handles over the shoulders or by holding the container handles, the pressure sensor is activated 512. In step 806 it is determined whether the container exceeds the preset weight limit. If not the process is ended. If the weight limit is exceed the process proceeds to step 808 and the pressure sensor sends a signal via WPAN 504 or other communicative technology to the user's mobile application 300 to signal if the container exceeds the appropriated weight limit. This is important, as users tend to carry more weight than appropriate for longer periods of time. This can potentially cause damage. In the absence of a user's entry for a container's weight limit, mobile application 300 will use external data sources for information on how much weight a user should be carrying based on demographics such as age, sex, height, build, etc. This demographic information can be input into the computerized method. This is important for parents to understand if their children are carrying more weight than appropriate for their age, size, and gender. The pressure sensor can also be used as a virtual scale so a user may understand the weight of a container such as a luggage, for example, without the need for a physical scale.

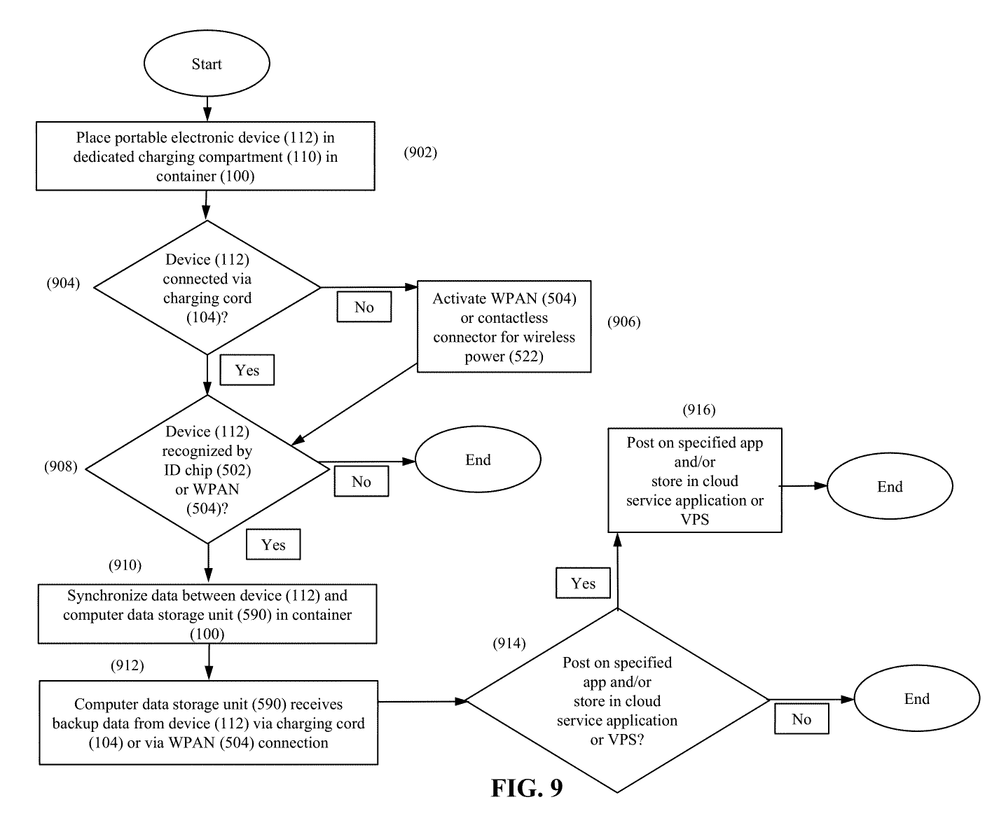

FIG. 9 is a flow chart illustrating the main steps leading to the backup of data from the mobile device to the container, according to some embodiments. FIG. 9 contains portable electronic device 112 in dedicated charging/holding compartment 110 and cord 104 that connects power supply 102 to portable electronic device 112, WPAN 504, contactless connector for wireless power 522, computer data storage unit 590, and computerized method, for example mobile application 300, according to some embodiments. In step 902, portable electronic device 112 is placed in dedicated charging compartment 110 in container 100. Next, in step 904, it is determined if device 112 is connected via the charging cord 104. If the device is not connected via the chagrining cord then in step 906 it is determined if the device is connected via activate WPAN (504) or contactless connector for wireless power 522. If the device is connected via the charging cord then the process proceeds to step 908. If the device is connected via activate WPAN (504) or contactless connector for wireless power 522 the process also proceeds to step 908. In step 908 the device 112 is checked against the information residing on integrated ID verification chip 502 or via a linked WPAN 504 to confirm the device is registered with the container. When a device 112 is placed into the dedicated charging compartment 110 in order to power up (either via cord 104 or contactless connector for wireless power 522) and is not a confirmed and registered device, no data backup occurs. This would be the case if a user chooses to power up a device belonging to a colleague or friend, for example. If device 112 is confirmed, the process will proceed to step 910 and it will begin synchronize data between device 112 and computer data storage unit 590 in container 100. Next the process will proceed to step 912 and computer data storage unit 590 receives backup data from device 112 via charging cord 104 or via WPAN 504 connection. In step 914, the user can select to auto-post selected data to a specified mobile application or to a cloud service application or VPS via computerized method. If the user selects to post on specified app and/or store in cloud service application or VPS, the process proceeds to step 916 and data is posted on specified app and/or store in cloud service application or VPS. A user can back up data when a device is not being used, and that data can be also pushed to another network or virtual storage when the user enters a private network, such as his or her home. This flow is important: data backup is power intensive, and using unknown networks to connect to servers means a user is at risk for breach of personal information. By backing up the data to a safe and personal host device such as a solid state hard drive 522 that has been integrated inside container 100 during device charging, a user can not only safely back up the device's data, but do so only when the device is charging inside the container and hence, not being used.

As set forth above, the container 100 can have a control circuit 250 for example, a microcontroller, microprocessor, or custom ASIC that interfaces with all of the hardware of the container. The control circuit is capable of controlling all of the features of the container. For example, the control circuit could control the power supply 102, light source 202, mechanical or magnetic latch and/or lock mechanism 206, or the GPS 510. The control circuit is also capable of running any of the processes described herein, for example the process of determining a recommendation for management of power 308. Control circuit 250 is embedded onto circuit board 526 along with the hardware it interfaces.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A portable power container comprising:
a power supply;
a compartment shaped to store the power supply;
a compartment shaped to store a mobile device;
an electrical distribution system for supplying power from the power supply to the mobile device;
an electrical coupling connected to the electrical distribution system for electrically coupling the mobile device to the electrical distribution system;
a controller electrically connected to the power supply; and
an electronically readable tangible storage medium comprising instructions that when executed cause the controller to:
monitor power consumption by the mobile device over time; and
regulate the power supplied from the power supply to the mobile device when the mobile device is electrically coupled to the electrical coupling.

2. The portable power container of claim 1 further comprising a light source electrically connected to the power supply disposed to illuminate the interior of the portable power container.

3. The portable power container of claim 2 wherein the light source included LED lighting.

4. The portable power container of claim 2 further comprising a closable opening, and the storage medium further comprising instructions that when executed cause the controller to supply power to the light source when the closeable opening is opened.

5. The portable power container of claim 4 further comprising:
an ambient light sensor;
the storage medium further comprising instructions that when executed cause the controller to regulate the power supplied to the light source based on information provided by the ambient light sensor.

6. The portable power container of claim 1 comprising at least two electrical couplings connected to the electrical distribution system for electrically coupling more than one mobile device to the electrical distribution system.

7. The portable power container of claim 1 wherein at least a portion of the electrical distribution system is integrated within the lining of the portable power container.

8. The portable power container of claim 1 wherein the power source is a fuel cell.

9. The portable power container of claim 1 the electrical coupling including at least one inductive charge coupling.

10. The portable power container of claim 1 further comprising a protective base that absorbs shock.

11. The portable power container of claim 1 wherein the portable power container uses a sensor to determine when the mobile device is inside the portable power container.

12. The portable power container of claim 1 further comprising a computer data storage unit for archiving information received form the mobile device.

13. A method comprising:
obtaining a measurement of a current amount of power remaining in a power supply of a portable power container;
transmitting a signal to cause a representation of the measurement to be displayed by a mobile device;
estimating a rate at which power from the power supply is consumed by the mobile device when charging the mobile device with the power supply;
determining a recommended power usage practice based on the rate at which power from the power supply is consumed; and
transmitting a signal to cause a representation of the recommended power usage practice to be displayed by the mobile device.

14. The method of claim 13 further comprising estimating a period of time the power supply will retain power based on the rate at which power from the power supply is consumed.

15. The method of claim 13 further comprising:
receiving information about scheduled activities of a user of the mobile device;
estimating an amount of power to be consumed by the scheduled activities; and
determining the recommended power usage practice being further based on the estimated amount of power to be consumed by the scheduled activities.

16. The method of claim 13 further comprising:
determining that too little power consumption data is available from the user to personalize a recommended power usage practice; and
using outside data sources to recommend a power usage practice.

17. The method of claim 13 further comprising the power supply charging the mobile device in accordance with the recommended power usage practice when the mobile device is electrically coupled to the power supply.

18. The method of claim 13 further comprising:
estimation of its own power consumption by the mobile device;
wireless transmission of the power consumption estimation by the mobile device; and
use of the power consumption information when making recommended power usage practice.

19. The method of claim 13 further comprising archiving information received from the mobile device.
